(19) United States
(12) Patent Application Publication
(10) Pub. No.: US 2007/0072534 A1
(43) Pub. Date: Mar. 29, 2007

(54) Tube status sensing method and control field of the invention

(75) Inventors: Joseph L. Levasseur, Chesterfield, MO (US); Steven M. Costello, O'Fallon, IL (US)

Correspondence Address: HAVERSTOCK, GARRETT & ROBERTS LLP, 611 OLIVE STREET, SUITE 1610, ST. LOUIS, MO, 63101, US

(73) Assignee: Coin Acceptors, Inc.

(21) Appl. No.: 11/234,909

(22) Filed: Sep. 26, 2005

(51) Int. Cl. G07D 9/00

(52) U.S. Cl. 453/17

(57) ABSTRACT

A method and system for determining the “fill” status of a coin tube in a coin handling device, including directing periodic incident waves of variable frequencies into the air space above the coins in the coin tube in an incremental fashion, under control of a processor, such as by use of a small speaker preferably positioned at or near the top of the coin tube, such that, for each incident wave, the periodic incident wave will be reflected by the closed bottom end of the coin tube and/or the coins therein, and the reflected wave will interact with the continuing incident wave to effect a resultant waveform in the open space above the coins. The resultant waveforms are monitored, such as by use of small microphone also preferably positioned at or near the top of the coin tube, and information therefrom is processed by the processor to determine the fundamental frequency for the air space above the coins in the coin tube, from which it is possible to calculate and determine the number of coins of a given type in the coin tube.

### FIELD OF THE INVENTION

The present invention relates to a method for sensing the “fill” status of a columnar or cache device, especially a coin tube or like device, and particularly for determining in “real time” the actual count of coins in a coin cache, and an apparatus for effecting such method.

### BACKGROUND OF THE INVENTION

Many prior art constructions have monitored coin tubes to try to determine the number of coins that remain available at any given time in coin tubes of a vending machine for use in making change or refunds, and attempts have often been made to try to maintain minimum or maximum numbers of coins in the tubes. Various of such constructions have employed optics utilizing various devices disposed in different configurations; some of such constructions have used inductive coils in various ways; and others of such constructions have used mechanical switches to determine the presence of coins at prescribed levels. Many of these constructions suffered from limitations that limited their abilities to determine an actual coin count in a tube at any given time.

A variety of prior art references address coin tube status and/or counts. U.S. Pat. No. 4,199,669 discloses a construction that utilizes a pivoting lever with a switch to sense the presence at coins at a lower level of a coin tube. U.S. Pat. No. 4,413,718 effects level testing by using a light source and detector on one side of a coin tube and a prism on the second side of the coin tube for returning the light from the light source to the detector by a different path. U.S. Pat. No. 4,460,033 detects a coin stack level by using a coil wound on a dumbbell shaped core and by pulsing the coil to produce a damped wave that is utilized to detect whether coins are present at the testing level. U.S. Pat. No. 4,491,140 teaches the use of only one sensed coin level for correcting a running total when a transition of that level occurs. U.S. Pat. No. 4,587,484 describes a way of determining coin tube levels by updating a running total by additions thereto and subtractions therefrom when coins enter or are discharged from the tube. U.S. Pat. No. 4,774,841 monitors the level of coins within a tube by directing a train of ultrasonic pulses towards the coin stack and measuring the interval between the emitted and reflected pulses. U.S. Pat. No. 5,092,816 shows the determination of a coin stack height by using the time interval from when a coin enters a tube to when the coin impacts the coin stack. U.S. Pat. No. 5,458,536 uses a technique of X by Y scanning with multiple positioned optical sensors. U.S. Pat. No. 6,267,662 B1 uses transmission lines on each side of a tube and sweeps through high frequencies while denoting amplitude changes to determine the coin stack height. GB 2257506A uses an optical elongate sensor. GB 2139352 discloses measurement of acoustic pulses produced by electric discharges. GB-A-2190749 uses a train of ultrasonic pulses directed towards the top of a coin stack and measures the time between the emitted and reflected pulses. GB 2357617A uses an electrical discharge through air, of thousands of volts which is controlled to provide ultra short pulses to enable measurement at closer distances. WO 97/35279 measures a token stack using ultrasonic pulses.

While the teachings of some of the prior art offered promise that better measurement of the coin stack could be provided, the implementation of such teachings, in light of requirements that actual constructions fit within available space, and be accurate, cost effective, and reliable, has been a challenge.

### SUMARY OF THE INVENTION

The method of the present invention introduces variable periodic waveforms into the airspace above the coins in a coin cache in a continuing fashion, such as by use of a small speaker positioned at or near the top of the coin cache, which may be a coin tube, a coin hopper, or other suitable coin holding device. A periodic incident wave so introduced into the top of the coin cache will be reflected by the closed bottom end of the coin cache and/or the coins disposed therein, and the reflected wave will interact with the continuing incident wave to effect a resultant waveform in the open space above the coins. The resultant waveform is monitored, such as by use of small microphone also positioned at or near the top of the coin cache, and information therefrom is processed to determine the “free” space above the coins, from which it is possible to calculate and determine the number of coins of a given type in the coin cache.

For ease of reference, the signal introduced by the speaker may sometimes hereafter be referred to as a driving or incident signal, the reflected signal may sometimes be referred to as the returning signal, and the signal detected by the microphone may hereafter be referred to as a resulting or resultant signal.

In addition, it should be understood that the term “coin” as employed herein should be considered to include not only standard monetary coinage, but also tokens, chips, and like items, as well as objects having like or similar properties, including objects, types of which may be of relatively uniform size and shape, that may be susceptible to storage in a tube or cache.

In one embodiment of the invention, the method employed determines whether and when the applied frequency is a resonant frequency for the air column above the coin stack, such as by determining when an in-phase relationship between the incident and the reflected signals occurs, and/or by monitoring and checking for peak amplitudes of the resultant signal, and makes use of multiple detected resonant frequencies and the relationships therebetween to determine the fundamental frequency of the air column.

An in-phase relationship occurs at the fundamental frequency of the air chamber, as well as at various odd harmonics thereof. With one preferred form of this embodiment, the true height of the “free space” or air chamber can be determined utilizing frequencies above the fundamental frequency. Once the “free space” height of the coin cache is determined, the “occupied space” height, e.g., the height of the coin stack, can be determined and the number of coins of a given coin type calculated.

In one preferred form of this embodiment, the speaker is driven by sine waves whose frequencies are varied over time until at least two conditions are detected in which the applied frequency is a resonant frequency of the air column above the coins in a coin tube. Such a condition occurs when the phase of the resulting signal detected by the microphone matches the phase of the signal introduced into the air chamber. As has already been noted, the achievement of an in-phase relationship occurs at the fundamental frequency of coin tube air chamber, as well as at various odd harmonics thereof.

The required determinations can be made such as by a processor portion of a device constructed in accordance with the invention. The processor portion may also be operable to variably control the frequency of the periodic waveform introduced into the air space to effect an in-phase relationship, and may be responsive to detection of an in-phase relationship to calculate a count of the coins present in the coin cache.

In another embodiment, the detected amplitude values of the resultant signal as associated with respective incident waveforms of varying frequencies may be employed to generate a signature waveform from which, by application of a mathematical transform or correlation, a greatest coefficient magnitude can be determined and utilized to determine the fundamental frequency for the “free space” height of the air chamber. Once the “free space” height of the coin cache is determined, the “occupied space” height, e.g., the height of the coin stack, can be determined and the number of coins of a given coin type calculated.

A preferred form of this embodiment may utilize Fast Fourier Transform (FFT) analyses to derive the desired information from the monitored resultant waveform and a processor portion of a device constructed in accordance with the invention.

In accordance with the invention, coin count determinations can be automatically made at scheduled times or periodically, upon the occurrence of certain events, or upon a local or remote request, including upon remote requests communicated wirelessly to the local system, and certain data for use with the local system, including, for example, float levels for coin tubes, can be established, monitored, and updated.

This invention thus provides a method and construction to determine the number of coins in a tube in “real time”, as well as to remotely, by wireless communication, obtain such information and establish and change float levels for coin tubes, and can also provide information as to when a coin enters a tube, as well as information as to when the coin tube becomes full or empty, or reaches an intermediate level.

### OBJECTS OF THE PRESENT INVENTION

It is a principal object of this invention to provide an improved method and apparatus to sense the “fill” status of a columnar or cache device, especially a coin tube or like device, and particularly to determine. in “real time” the actual count of coins in a coin cache.

Other objects and advantages may be further or additionally realized by this invention or by particular embodiments thereof.

For example, through use of the invention, the height of an air chamber above a coin stack in a coin tube can be determined by using signals that do not have to be of very short duration, and periodic waveforms of varying frequencies can be introduced into a coin tube on a continuing basis to determine coin tube counts.

Additionally, with some embodiments of the invention, one could determine the level of coins in a tube, even if coins have been manually added or removed during power interruption.

Certain embodiments are also capable of providing real time inventory information for on-line or other remote inquiries.

Some preferred embodiments may allow float level control of individual coin tubes by authorized manual or remote wireless communication means.

Various embodiments may include components to provide for enhanced accuracy, such as by tracking temperature changes, and select embodiments may provide a method that will indicate the arrival of a coin into the coin tube for complying with controller requirements of a coin changer or for other reasons.

### BRIEF DESCRIPTION OF THE DRAWINGS

FIG. 1 depicts a simplified representation of a speaker diaphragm and its movement as related air pressure changes occur at one side thereof.

FIG. 2 depicts a representation of a fundamental frequency (first harmonic) sound wave within the air chamber above a coin stack in a coin tube, indicating the incident and reflected sound waves within the air chamber and the air pressure variation throughout the air chamber at resonance, with the air chamber above the coin stack having a height equal to one-quarter (¼) of the wavelength of the frequency of the sound wave.

FIG. 3 is similar to FIG. 2, but depicts a representation of a third harmonic frequency sound wave within the coin tube, with the air chamber above the coin stack having a height equal to three-quarters (¾) of the wavelength of the frequency of the sound wave.

FIG. 4 is similar to FIGS. 2-3, but depicts a sound wave representation of a fifth harmonic frequency within the coin tube, with the air chamber above the coin stack having a height equal to five-quarters ( 5/4) of the wavelength of the frequency of the sound wave.

FIG. 5 is similar to FIGS. 2-4, but depicts a representation of a sound wave that is not resonant, indicating the incident and reflected sound waves within the air chamber and the air pressure variation throughout the air chamber.

FIG. 6 is a simplified drawing of a coin tube depicting the relative placements of a small speaker and a small microphone at the top of a coin tube.

FIG. 7 is a table identifying fundamental (first harmonic) frequencies as well as third, fifth, and seventh harmonic frequencies for different lengths of a representative closed-end air column.

FIGS. 8-10 are drawings each depicting a waveform of a resultant signal relative to incident and reflected signals, with each drawing illustrating the relative phasing between the representative incident and resultant signals.

FIGS. 11-13 are high level flow charts illustrative of several manners in which differentiable forms of one embodiment of the invention may be realized.

FIG. 14 is a simplified schematic of a phase comparator such as can be employed in effecting the invention.

FIG. 15 is a block diagram depicting a particular embodiment of the invention.

FIG. 16 is an illustration showing representative driving and resultant logic signals as they may be effected in the embodiment of FIG. 15, with such logic signals being in-phase.

FIG. 17 is similar to FIG. 10 but depicts the driving logic signal leading the resultant logic signal by 300 degrees, which is equivalent to the driving logic signal lagging the resultant logic signal by 60 degrees.

FIG. 18 is also similar to FIG. 10 but depicts the driving logic signal leading the resultant logic signal by 60 degrees.

FIG. 19 depicts representative output signals such as might be generated by the phase detection circuitry of FIG. 14 and communicated to the microprocessor of FIG. 15.

FIG. 20 is a high level flow chart illustrative of the manner in which the constructions of FIGS. 14-15 can operate to determine and apply, in real-time, succeeding frequencies to effect a resonant condition.

FIG. 21 depicts a periodic triangular waveform as another example of a periodic waveform that can be utilized as a driving signal.

FIG. 22 is a high level flow chart illustrative of a typical operation of the construction of FIG. 15 in a vending environment.

FIG. 23 is a graphical representation of a quarter tube fill status over time, such as might be detected utilizing the present invention.

FIG. 24 is a figure depicting signature waveforms such as might be generated for three different closed-end air columns.

FIGS. 25 and 26 are figures illustrating how FFTs can be applied with respect to particular waveforms.

FIG. 27 is a figure depicting a particular signature waveform for a 0.20 m. coin tube having a 0.15 m. air column above stacked coins.

FIG. 28 is a figure depicting a FFT of the wave of FIG. 27.

FIG. 29 is a simplified representation of a bulk loaded coin hopper such as might also utilize the present invention.

### DETAILED DESCRIPTION OF THE PREFERRED EMBODIMENT

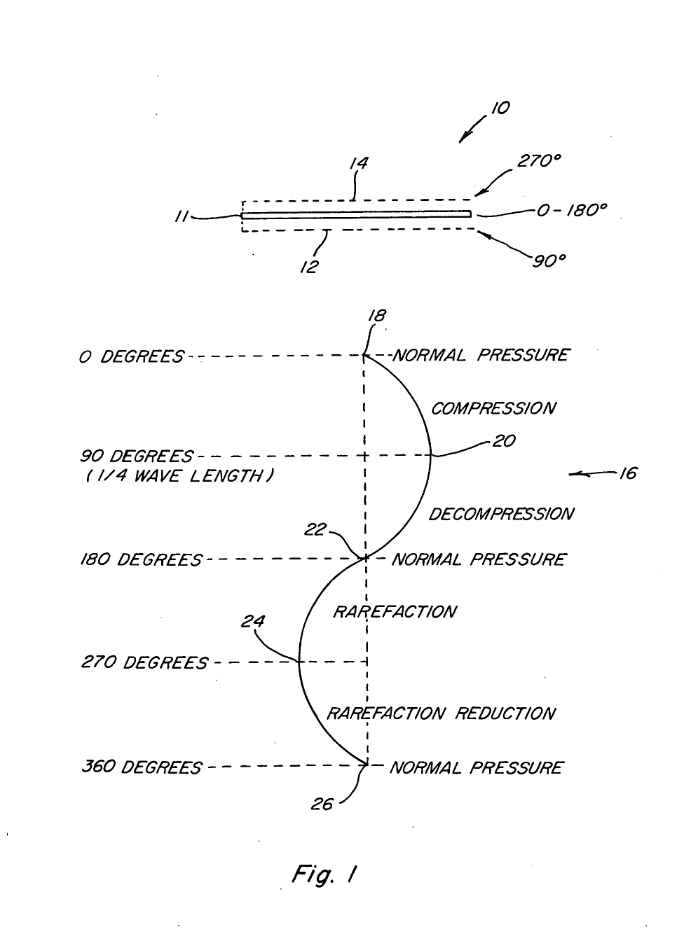

FIG. 1 depicts a representation of a small speaker diaphragm 10 and a representation of a pressure wave that is generated as the speaker diaphragm is caused to move. The speaker diaphragm is shown positioned at a nominal (static) condition 11, such as would occur at zero or 180 degree time points when a periodic wave is applied to one side of the diaphragm 10. The dashed line 12 shows the diaphragm 10 at its 90-degree maximum downward compression position, and dashed line 14 shows the 270-degree position of the speaker diaphragm, when the diaphragm is at maximum rarefaction in respect to the downward direction.

The air pressure wave that results at the lower side of the speaker diaphragm 10 in response to application of sinusoidally varying air pressure to the upper side of the speaker diaphragm during one complete cycle is represented by the sine wave 16, starting at the zero degree time point 18 at normal (ambient) air pressure and proceeding to a 90-degree time point 20, which is the maximum pressure point when speaker diaphragm 10 is at position 12. The diaphragm 10 thereafter returns to its initial position 11 at the 180 degree time point 22 and proceeds to its maximum rarefaction position 14 at the 270-degree time point 24. The time interval between the zero degree time point 18 and the 360-degree time point 26 is the duration of one period 17, which corresponds to one wavelength of the periodic signal 16 applied to the diaphragm 10.

In accordance with general physical principles, when a pressure wave is introduced into a closed end air tube, the wave propagates through the air chamber in the tube until it impinges the closed end, where it is (partially) reflected and inverted. When the incident waveform is a continuing periodic waveform, the incident waveform and the reflected waveform interact with one another to establish a standing wave having nodes and anti-nodes within the air column. Thus, when a compression is introduced into the open end of an air column within a tube, that compression will travel the length of the tube and will reflect off the closed end as a rarefaction (i.e., it will invert upon reflection off the closed end). Such rarefaction will then return towards the open end of the tube, and, in doing so, will interact with other portions of the continuing incident wave traveling towards the closed end. If the noted reflected rarefaction reaches the open end of the tube as the initial rarefaction of the continuing incident wave is being introduced into the tube, one-half wavelength of the periodic wave will have traveled from the open end of the tube, reflected off its closed end, and returned to the open end.

In such a situation, the air column of the tube has a length [symbol] _{A} equal to one-fourth (¼) the wavelength of the periodic waveform [symbol]
_{A}=λ_{I}/4,
where λ_{I} is the wavelength of the incident waveform and [symbol] _{A} is the length of the closed-end air column. The incident and reflected waves in the tube interact such that a standing wave is established within the tube with a pressure anti-node at the open end of the tube and a pressure node at the closed end of the tube, and the incident signal has a frequency f_{I} that is the resonant, fundamental frequency f_{F} (sometimes also called the first harmonic frequency) of the air column.

As will be further explained hereinafter, these principles may be utilized to determine the number of coins in a coin tube or coin cache.

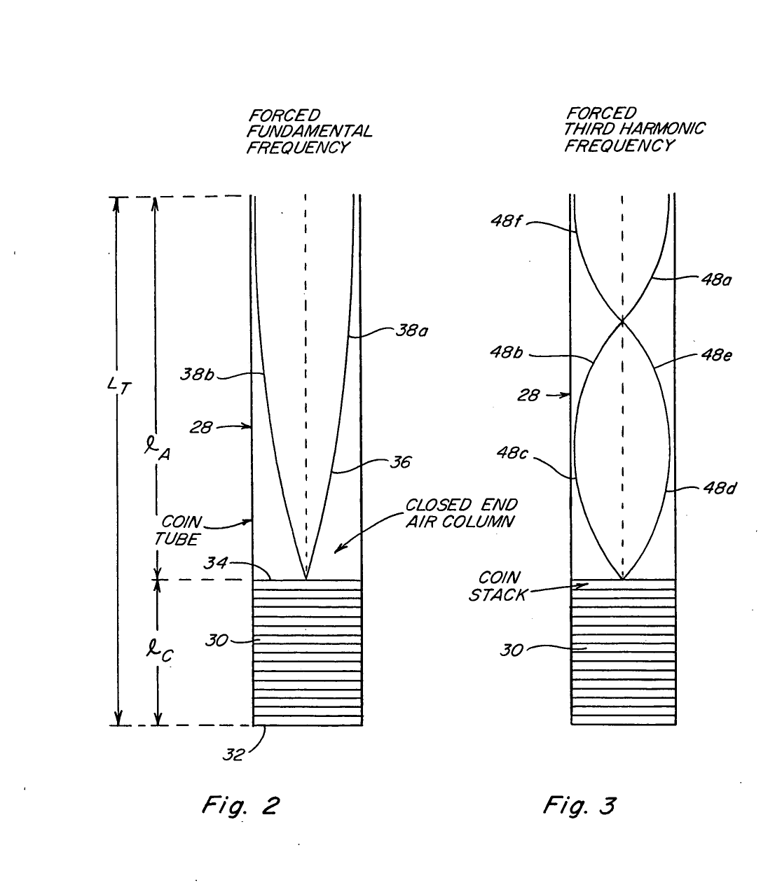

In FIG. 2, a coin tube 28 of height L_{T} (length of the tube) is shown with a coin stack 30 of height [symbol] _{C} (length (height) of the coin stack within the tube), which extends from the bottom 32 of the coin tube 28 to a position at top 34 of the coin stack 30, and a closed-end air column 36 of height [symbol] _{A} is disposed above the stacked coins, such that [symbol]
_{A}=L_{T}− [symbol] _{C}.

From the foregoing discussion, it will be appreciated that resonance occurs within the air column 36 above the stacked coins 30 at a fundamental frequency f_{FA} (fundamental frequency of the air column) that has a wavelength four times that of the air column, i.e.,
λ_{A}=4 [symbol] _{A},
where λ_{A} is the wavelength of the air column. Such a resonant condition is depicted in FIG. 2. A one-fourth (¼) wavelength chord 38a of a sine wave, such as the sine wave 16 depicted in FIG. 1, represents the introduction and travel of a sine wave within the air column 36 to impinge the top of the coin stack 30. The one-fourth (¼) wave length chord 38b represents the inverted reflected sound wave.

From the foregoing, it should also be appreciated that a relationship thus exists between and among the fundamental frequency of the air column f_{FA}, the height of the air column [symbol] _{A}, and the speed of the pressure wave in the air column, which may be expressed as
f_{FA}=v/4 [symbol] _{A}=v/λ_{A},
where v is the velocity of the pressure wave. The fundamental frequency f_{FA} (in cycles) for a closed-end air column, when the wavelength λ_{A} (in meters) and the speed of the sound v (in meters per second) are known, can be determined by dividing the speed by the wavelength. The speed of the pressure wave in an air column is the speed of sound, which may be determined in accordance with the formula
v=331 m/s+((0.6 m/s/° C.)*T),
where T is the temperature in degrees Celsius. Therefore, at a temperature at 20° C. (68° F.),
v=331 m/s+(0.6 m/s/° C.*20° C.)=331+12=343 m/s≈13,503.9 in./s,
and the fundamental frequency for a closed-end air column is determined by the formula
f_{FA}=V/λ_{A}=v/4 [symbol] _{A}=343/4 [symbol] _{A}=85.75/ [symbol] _{A},
where [symbol] _{A} is measured in meters, or
f_{FA}=v/λ_{A}=v/4 [symbol] _{A}≈13,509/ [symbol] _{A}=3375.975/ [symbol] _{A},
where [symbol] _{A} is measured in inches.

FIG. 3 shows the same tube 28 and coin stack 30 as FIG. 2, but with a driving signal that has a frequency that is the third harmonic (three times the fundamental frequency)
f_{3H}=3f_{FA,}
where f_{3H} is the third harmonic frequency for the air column in the coin tube. Because the wavelength of the third harmonic is three times shorter than the wavelength of the fundamental frequency, there are three times the number of pressure changes occurring within the air column. Thus, while the number of “one-fourth wavelengths” to complete the round trip in FIG. 2 is two (e.g., chords 38a and 38b), in FIG. 3 six “one-fourth wavelengths” (e.g., chords 48a-48f) are required to complete the round trip. The third harmonic frequency results also in an in-phase relationship.

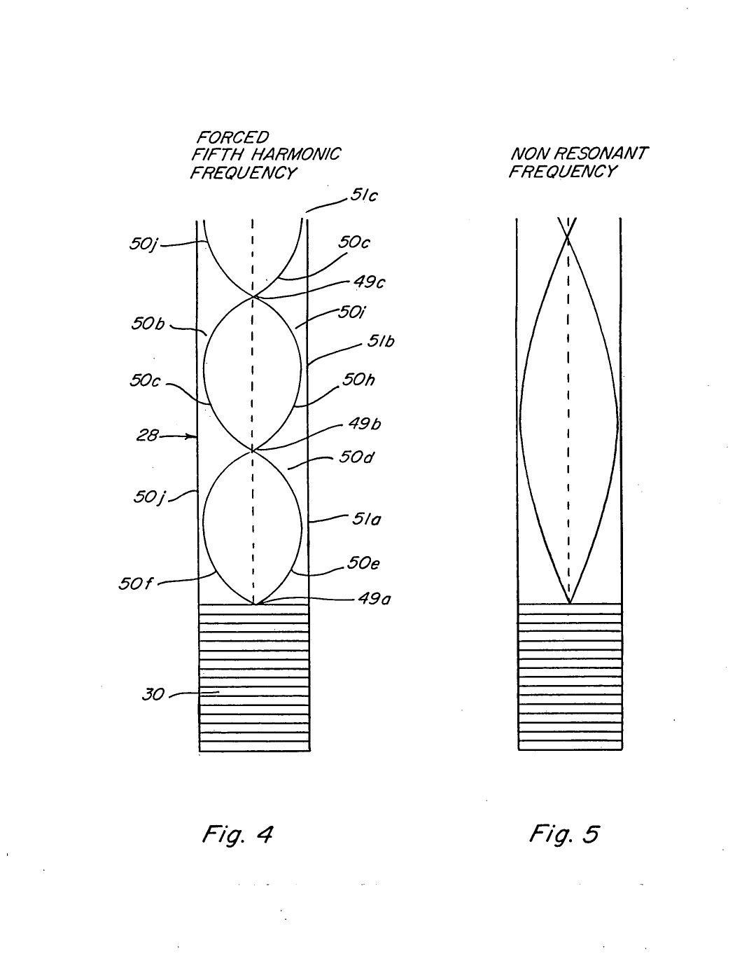

Again, in FIG. 4, the same tube 28 and coin stack 30 are depicted as in FIG. 2, but with a driving signal that has a frequency that is the fifth harmonic
f_{5H}=5f_{FA,}
where f_{5H} is the fifth harmonic frequency for the air column in the coin tube. As can be observed, such fifth harmonic has a total of ten “one-fourth wavelengths” (e.g., chords 50a-50j) associated with it.

The three examples in FIGS. 2, 3, and 4 all depict situations in which there exist in-phase relationships between the driving signal and the reflected signal at resonant frequencies for the particular air column height.

If driving signals with frequencies that are above or below a resonant frequency of the air column are instead introduced into the air column, detectable phase differences between the driving signal and the resultant signal will become evident. FIG. 5 depicts the same tube 28 and coin stack 30, but with an applied driving signal 52 that is not one of the resonant frequencies for the air column above the coin stack. The reflected signal 54 interacts with the incident signal such that the resultant signal is out of phase with the incident signal.

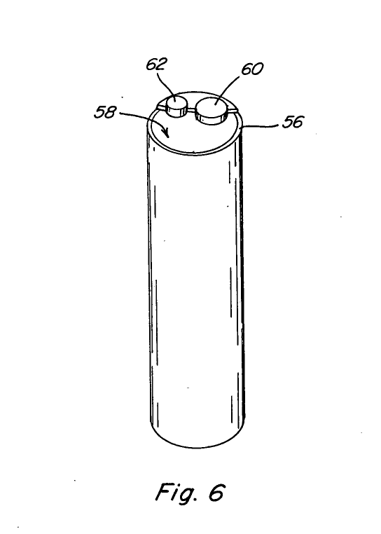

FIG. 6 depicts a representative coin tube 56 having a coin entrance opening 58 at its top end with a small speaker 60 positioned to direct sound waves into the coin tube 56 and a microphone 62 to monitor the resultant signals in the coin tube 58. Because of the method of the present invention, it is practical and preferred for the speaker and the microphone to be located at or very close to the top of the coin tube.

(In the past, most ultrasonic measuring systems required that transducers be located some distance away from the closest point to be measured. The distance was typically dependent upon how short the pulse could be made in order to measure the shortest time requirement of the reflected pulse. With such systems, an absence of any pulse is required during the lapse time of the reflected pulse. The present invention does not require a very short pulse in order to operate because it utilizes signals with wavelengths that remain during the measurement process. Distances shorter than the signal wavelength can thus be determined without placing the abrupt requirement on the transducers, and, the distance of transducers away from the tube is therefore not an issue.)

As has been discussed hereinbefore, it is known that, for a closed-end air column, resonance occurs both at a fundamental frequency f_{FA} that has a wavelength that is four times the air column length, that is
λ_{A}=4 [symbol] _{A,}
and at odd harmonics thereof. Thus, for an air column of 16 centimeters length, the wavelength of the fundamental frequency is known to be 64 centimeters (0.64 m.) and the fundamental frequency and odd harmonics can be readily calculated.

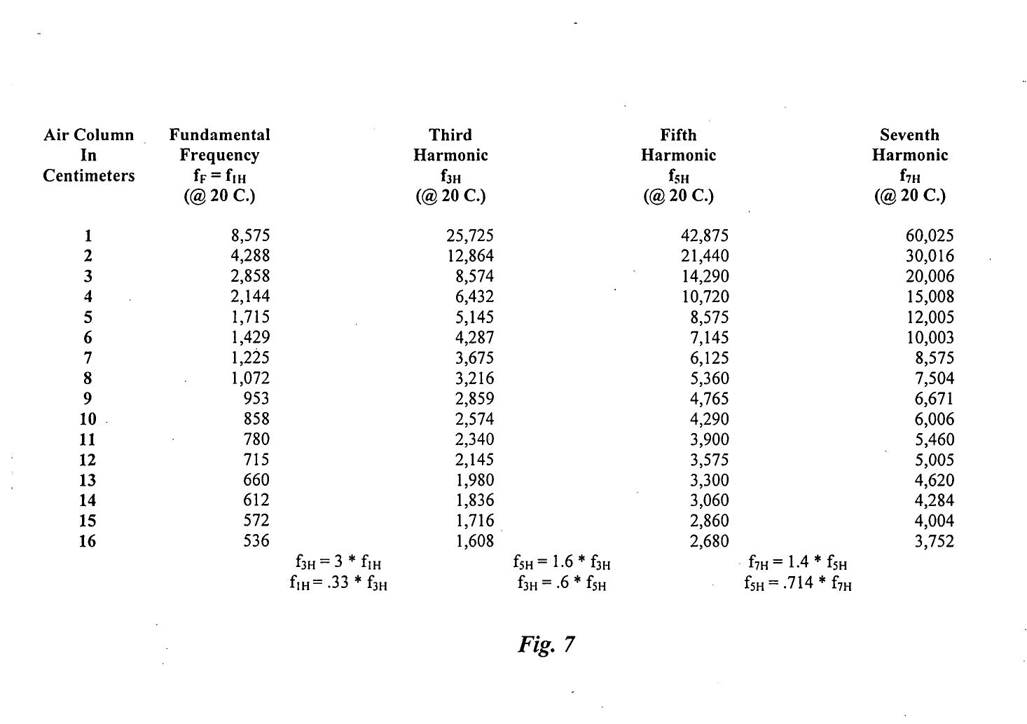

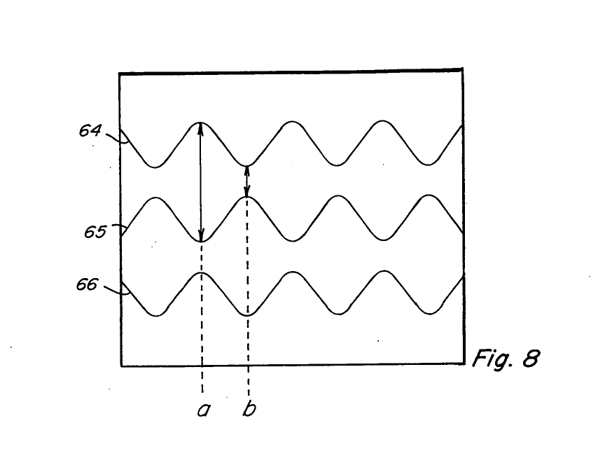

FIG. 7 is a table identifying the fundamental (first harmonic), third harmonic, fifth harmonic, and seventh harmonic frequencies associated with various particular air column heights (expressed in centimeters) in air at a temperature of 20 degrees Celsius. By way of illustration, for an air column having a length [symbol] _{A}=16 cm., at 20° C. the fundamental frequency is thus 536 Hz, the third harmonic frequency is 1,608 Hz, the fifth harmonic frequency is 2,680 Hz, and the seventh harmonic frequency is, 3752 Hz.

From what has been already discussed, it should be apparent that, while application of a driving signal that is the fundamental frequency or an odd harmonic of the air column above a coin stack will result in a resonance condition, the same cannot be said of other frequencies applied to the air column. Moreover, if the height of the air column is caused to change, such as by the receipt into the coin tube of additional coins or the dispensing from the coin tube of coins present therein, the resonance condition obtained with a particular driving frequency will be disturbed.

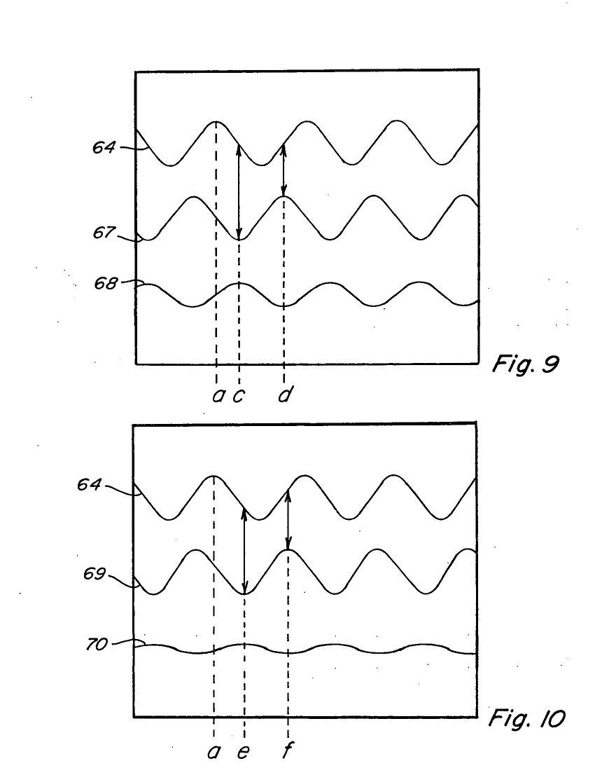

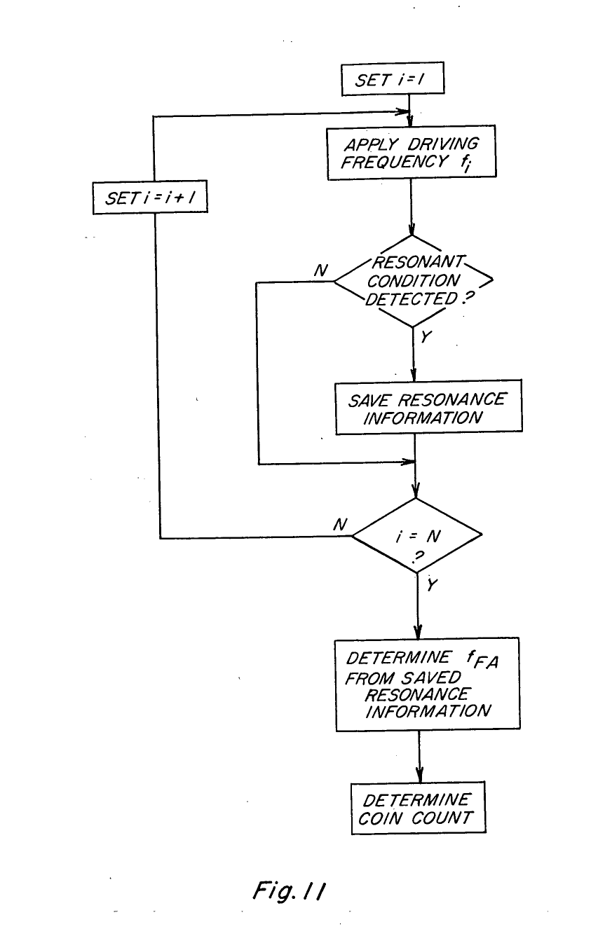

FIGS. 8-10 illustrate how such changes might be evidenced in driving, reflected, and resultant signals. FIG. 8 depicts a resonant condition involving a continuing incident wave 64, a returning, reflected wave 65, and a resultant wave 66, with the reflected wave shown at maximum rarefaction while the incident wave is at maximum compression at point a and with both the incident and reflected waves shown at normal pressure at point b. In this condition, the incident and resultant signals are in-phase, with the maximal amplitude of the resultant wave occurring at point a, which is also the maximal amplitude of the incident wave. In contrast thereto, in FIG. 9 the returning, reflected wave 68 is shown with its maximum rarefaction occurring at point c, instead of point a, and normal pressure at point d, as result of which the resultant wave 68 is therefore approximately 90° out-of-phase with incident wave 64, as shown at point a, and has a reduced maximal amplitude which occurs at point c. Somewhat similarly, in FIG. 10 the returning, reflected wave 69 is shown with its maximum rarefaction occurring at point e, instead of point a, and normal pressure at point f, as result of which the resultant wave 70 is therefore approximately 120° C. out-of-phase with the incident wave, as shown at point a, and has greatly reduced maximal amplitude which occurs at point e.

For closed-end air columns, only the fundamental and odd harmonic frequencies will produce an in-phase relationship between the driving and the reflected signals; even harmonic frequencies result in a 180° out-of-phase relationship.

As will be discussed in greater detail hereinafter, the microphone 62 can monitor the resultant signal produced in the air column above the coin stack in coin tube 56 in response to a driving signal introduced into the air column by the speaker 60, and the monitored information can be utilized to determine whether, in response to a given driving signal, a resonant condition is established. As the driving signal from the speaker is varied, the resultant signal may move into and out of resonance.

When a resonant condition is found to exist, it may not immediately be apparent whether the driving signal that has effected such resonant condition is the fundamental frequency or some other odd harmonic of such fundamental frequency. For example, as can be observed from FIG. 7, if resonance occurs at a frequency of about 1715-1716 Hz, it may not immediately be apparent whether the frequency is the fundamental frequency for an air column of 5 cm. or is the third harmonic for an air column of 15 cm. However, because of mathematical relationships between and among fundamental frequencies and their odd harmonics, one can readily test and ascertain, by observing whether resonance also occurs at certain higher or lower frequencies than the particular frequency at which resonance has been detected, whether that initial detected resonant frequency is the fundamental frequency or is a harmonic frequency. As can also be observed from FIG. 7, the third harmonic frequency is three times the fundamental (first harmonic) frequency, while the fifth harmonic frequency is approximately 1.67 times the third harmonic and the seventh harmonic is approximately 1.4 times the fifth harmonic. Similar relationships apply with regard to higher odd harmonics. Such relationships provide a basis for one of the embodiments of the present invention.

Thus, by way of example, if, for a given air column, resonance is detected at a particular frequency, the further detection of resonance at odd multiples of that particular frequency can serve to validate that particular frequency as the fundamental frequency of the air column. However, if resonance is, instead, detected at a frequency approximately 1.67 times the detected resonant frequency, such condition would tend to indicate that the particular resonant frequency initially detected was a third harmonic and that the new resonant frequency is a fifth harmonic. In such event, the fundamental frequency could be calculated by dividing the initially found (third harmonic) frequency by 3.

Consequently, in general, once a resonant frequency is detected, the driving frequency can be varied to determine other driving frequencies at which resonance occurs. Based upon the relationships between the driving conditions that result in resonance, the fundamental frequency of the air column can be determined.

One embodiment of the invention relies upon and makes use of such relationships, and can take various forms. Once multiple resonant conditions have been detected, the frequency relationships between such resonant frequencies can be utilized to identify the fundamental frequency for the air column.

In such regard, as has already been discussed,
f_{FA}=v/λ_{A}=v/4 [symbol] _{A},
λ_{A}=4 [symbol] _{A},
f_{3H}=3f_{FA},
f_{5H}=5f_{FA}.=1.67 f_{3H,} and
f_{7H}=7f_{FA}.=1.4 f_{5H.}

Once the harmonic content for the resonant signals has been established, the height [symbol] _{A} of the air column in the coin tube can be readily determined since [symbol]
_{A}=λ_{A}/4=0.25* λ_{A}=0.25v/f_{FA}, [symbol]
_{A}=λ_{A}/4=0.25*λ_{A}=0.25v/f_{FA}=0.25v/(f_{3H}/3)=0.75v/f_{3H}
and [symbol]
_{A}=λ_{A}/4=0.25*λ_{A}=0.25v/f_{FA}=0.25v/(f_{5H}/5)=1.25v/f_{5H},
where v is a constant equal to 334 m/s at 20° Celsius.

Once [symbol] _{A} is thus determined, the height [symbol] _{C} of the coin stack can then also be determined, and the number of coins of a given thickness in the coin stack can thereafter be calculated using the formulae [symbol]
_{C}=(L_{T}− [symbol] _{A}), [symbol]
_{C}=n*Cₜ,
and
n= [symbol] _{C}/Cₜ=(L_{T}− [symbol] _{A})/Cₜ,
where n is the number of coins in the coin stack, [symbol] _{C} is the height of the coin stack, L_{T} is the height (or length) of the coin tube, [symbol] _{A} is the height of the air column above the coin stack, and Cₜ is the thickness of an individual coin.

It will be appreciated and understood by those skilled in the art that, as a continuing periodic signal of a given frequency is directed into an air column, the resultant established signal within the air column will be a standing wave that may have a number of pressure nodes and anti-nodes. For example, with reference to FIG. 4, pressure nodes are apparent at locations 49a, 49b, and 49c, while pressure anti-nodes are apparent at locations 51a, 51b, and 51c. As has already been discussed, when a resonant condition has been established, a pressure anti-node, such as the anti-node 51c, occurs at the open end of the coin tube.

It will also be appreciated that a pressure standing wave for a given driving frequency can be rapidly established within a coin tube. Since a sound wave travels at a speed of 334 m/s in air at 20° Celsius, for an air column of 0.25 meters (approximately 9.84 in.), the time necessary for the waveform to traverse the air column twice, once from the open to the closed end and then back from the closed end to the open end, and to establish a standing wave would be only about 1.5 milliseconds. Depending upon the maximum height of a coin tube undergoing testing, appropriate durations of application of varying periodic waveforms can be pre-determined to ensure that the resultant signals monitored by the microphone 62 can be relied upon in terms of determining the existence of a resonant condition in response to a particular driving frequency.

It will also be understood and appreciated that, upon the occurrence of a resonant condition, the amplitude of the resultant wave will be at a peak value and the resultant wave will be in-phase with the incident wave, as can be observed from FIGS. 2-4 and 8. On the other hand, if the driving frequency is neither the fundamental frequency nor an odd harmonic of the air column, the amplitude of the resultant wave will be reduced and the resultant wave will be out-of-phase with respect to the incident wave, as can be observed from FIGS. 5, 9, and 10.

Consequently, by applying incident waves of varying frequency to a coin tube and monitoring the resultant wave, including as resonant conditions are detected, such as by monitoring the phase relationship between the resultant signal and the incident signal and/or the amplitude of the resultant signal, the fundamental frequency for the air column in the coin tube can be determined, and based upon such determination, the number of coins of a given coin type in the coin stack within the coin tube can be calculated.

In such regard, it should be understood that either or both the phase of such resultant wave relative to the incident wave and/or the detected amplitude of the resultant wave may be utilized to ascertain when a resonant condition exists and to then determine the fundamental frequency.

As noted hereinbefore, an embodiment of the invention that relies upon the detection of multiple resonant conditions and the relationships therebetween can take various forms.

In accordance with one form of such embodiment, periodic signals of varying frequencies may be applied in a given order to a coin tube of a predetermined height having a coin stack of unknown height therein, and the resultant signals within the air column of the coin tube monitored to note those input frequencies which result in the establishment of resonant conditions. By then determining the ratios of such resonant frequencies to one another, the fundamental frequency of the air column can be determined, from which the number of coins of a given coin type in the coin stack within the coin tube can be derived. The range of incident frequencies can be predetermined based upon the coin tube height and the minimal air column height that will be encountered. The incident frequencies may be applied in a sequential or incremental fashion.

FIG. 11 presents a high level flowchart illustrative of one manner in which such a form of the embodiment could be realized. In accordance with such flowchart, differentiable periodic driving signals from a given set of frequencies could be applied in a stepwise or incremental fashion, and the resultant signal monitored to detect the establishment of resonant conditions. Whenever a resonant condition is detected, the information associated with that condition would be saved. When the application of all the driving signals from the given set of frequencies has occurred, a determination of the fundamental frequency can be made based upon the relationships between the various resonant conditions detected. From the fundamental frequency, the coin count in the coin stack can then be determined in accordance with the teachings set forth hereinbefore. The given set of frequencies can be pre-determined, based, for example, upon the minimum and maximum air columns possible, to ensure that at least two resonant conditions will be realized for each application of the given set. Generally, if the given set is based upon the minimum and maximum air columns possible, more than two resonant conditions will result as the entire set of frequencies is applied.

In accordance with another form of such embodiment, periodic signals of varying frequencies may be applied to a coin tube of a predetermined height having a coin stack of unknown height therein, and the resultant signals within the air column of the coin tube monitored until a first resonant condition occurs as a result of application of an incident signal of a particular frequency. Since that particular incident frequency is the fundamental frequency or some odd harmonic thereof, a further sequence of incident signals may be applied until a second resonant condition occurs. Based upon the relationship between the two incident signals that resulted in resonant conditions, the fundamental frequency of the air column can be determined, from which the number of coins of a given coin type in the coin stack within the coin tube can then be derived.

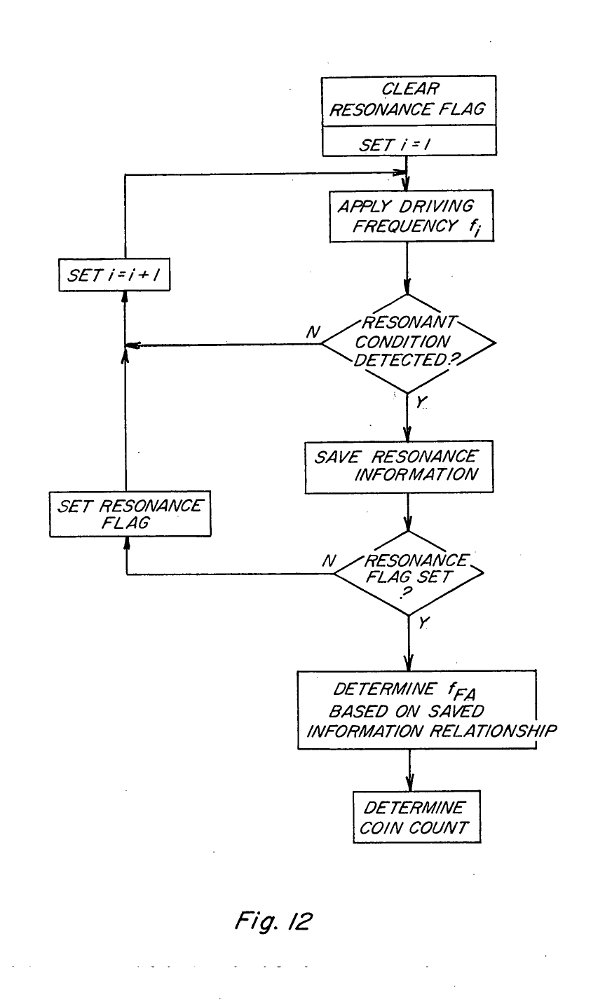

FIG. 12 is similar in certain respects to FIG. 1 1 and presents another high level flowchart illustrative of such another form of the embodiment that could be realized, wherein a determination of the coin count can be effected without necessarily having to await the application of the entire given set of frequencies. In accordance with such flowchart, differentiable periodic driving signals from a given set of frequencies could be applied in a stepwise or incremental fashion until a first resonant condition is detected and the information associated therewith saved. Thereafter, further differentiable periodic signals from a second given set of frequencies could be applied in a stepwise or incremental fashion until a second resonant condition is detected. The second given set of frequencies could be a subset of the first given set or a separate set of frequencies, including a set based upon the frequency at which the first resonant condition was detected. Based upon the information from the two resonant conditions detected and the relationships between such resonant conditions, a determination of the fundamental frequency can be made and the coin count in the coin stack determined. The FIG. 12 manner would be expected to generally more quickly allow a determination of the coin count than the manner of FIG. 11.

In accordance with still another form of such embodiment, periodic signals of varying frequencies may be applied to a coin tube of a predetermined height having a coin stack of unknown height therein, and the resultant signals within the air column of the coin tube monitored until a first resonant condition occurs as a result of application of an incident signal of a particular frequency. Since that particular incident frequency is either the fundamental frequency or some odd harmonic thereof, additional incident signals having frequencies of particular relationships (e.g., 1.4×, 1.67×, 3×) with respect to that incidental frequency giving rise to the detected resonant condition can be sequentially applied until a second resonant condition is detected. Based upon the particular relationship that the latter incident signal bears to the particular incident signal that resulted in the first resonant condition, the fundamental frequency of the air column can be determined, from which the number of coins of a given coin type in the coin stack within the coin tube can then be derived.

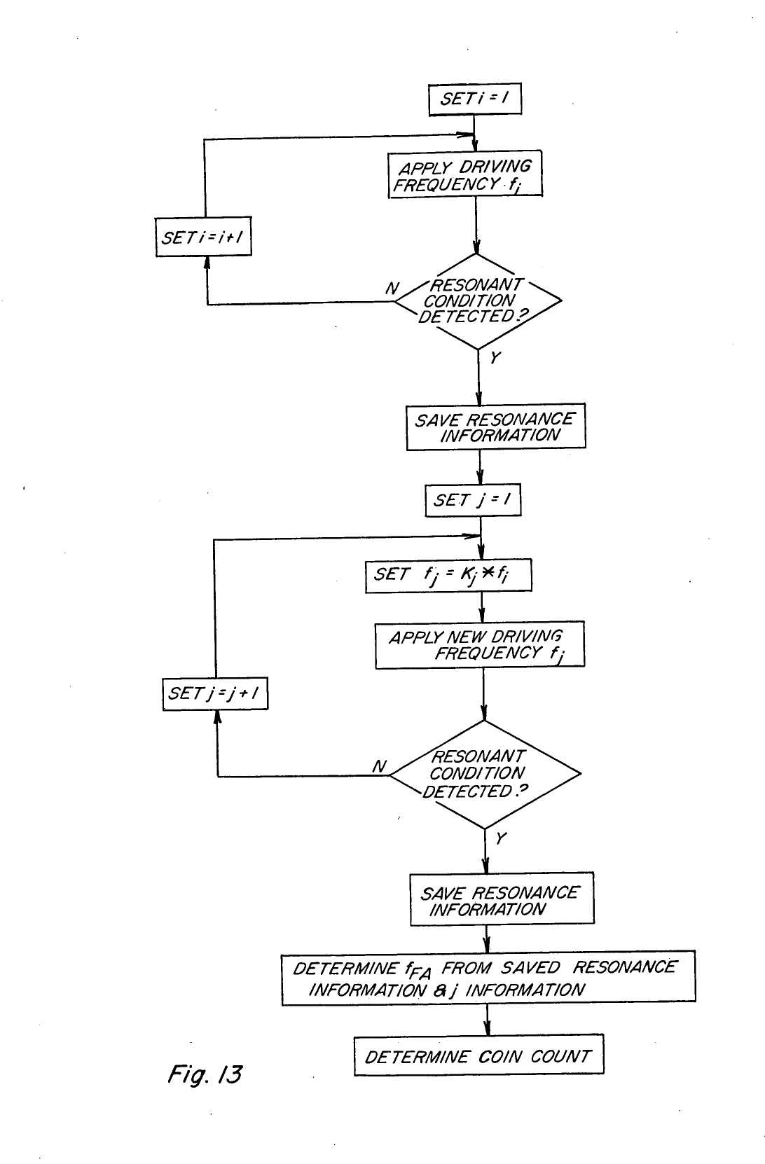

FIG. 13 is similar in certain respects to both FIGS. 11 and 12 and presents still another high level flowchart illustrative of this other form of the embodiment that could be realized, wherein, once a first resonant condition is determined and the associated information for that condition saved, subsequent applications of driving signals are at frequencies from frequency sets whose frequencies are odd harmonics (including fundamental frequencies as 1^{st} harmonics) and include the frequency at which the first resonant condition was detected. The differentiable periodic signals of those frequencies would be applied in a stepwise or incremental fashion until a second resonant condition is detected. Based upon the information from the two resonant conditions detected and the relationships between such resonant conditions, a determination of the fundamental frequency can be made and the coin count in the coin stack determined. The FIG. 13 manner would be expected to generally even more quickly allow a determination of the coin count than the manner of FIGS. 11 and 12.

It will be recognized by those skilled in the art that the above-noted forms are but several possible forms and that any forms that provide detections of resonant conditions for multiple, different incident frequencies could be advantageously employed. In general, those forms that minimize the number of different incident frequencies that must be applied are considered more preferable since the time required to determine the coin count can be minimized.

While reference has been made in the foregoing to the use of a given set of frequencies and the application of driving frequencies in accordance therewith, it should be understood that, instead of utilizing a pre-established or pre-determined set of frequencies, the particular frequencies utilized and their order of use may be based upon or determined from previously applied frequencies and/or from the resultant signal, and succeeding frequencies may be determined and generated for application on a real-time basis, as will become further apparent hereinafter.

It should also be appreciated that, in general, the existence of resonant conditions can be determined with reference to either or both the resultant signal phase and amplitude. When a resonant condition exists, the resultant signal would be expected to exhibit maximal amplitude and to be in-phase with the incident signal. Consequently, various forms of the embodiment may be designed to detect maximal amplitudes or in-phase relationships or both as indicators of resonant conditions.

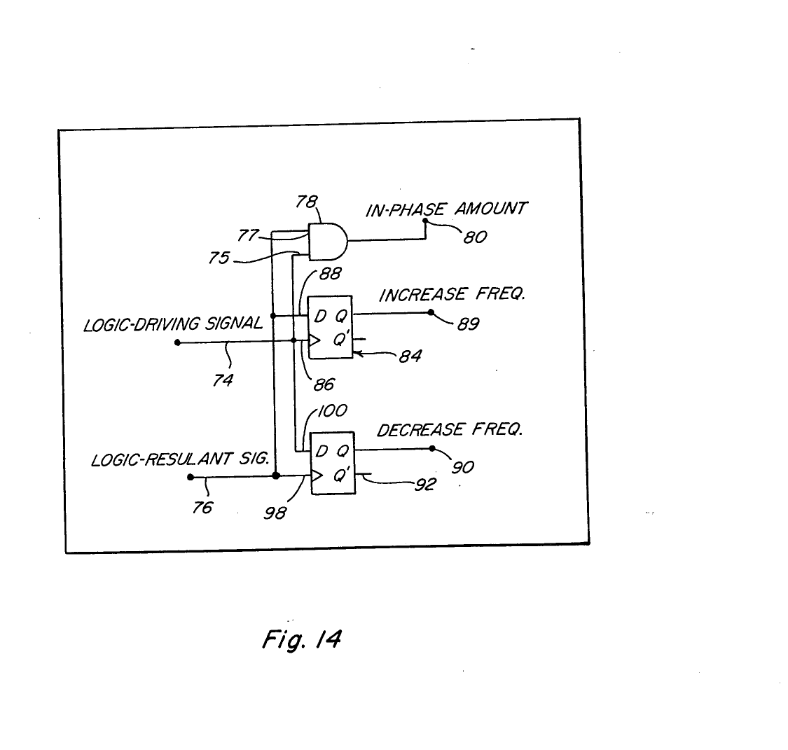

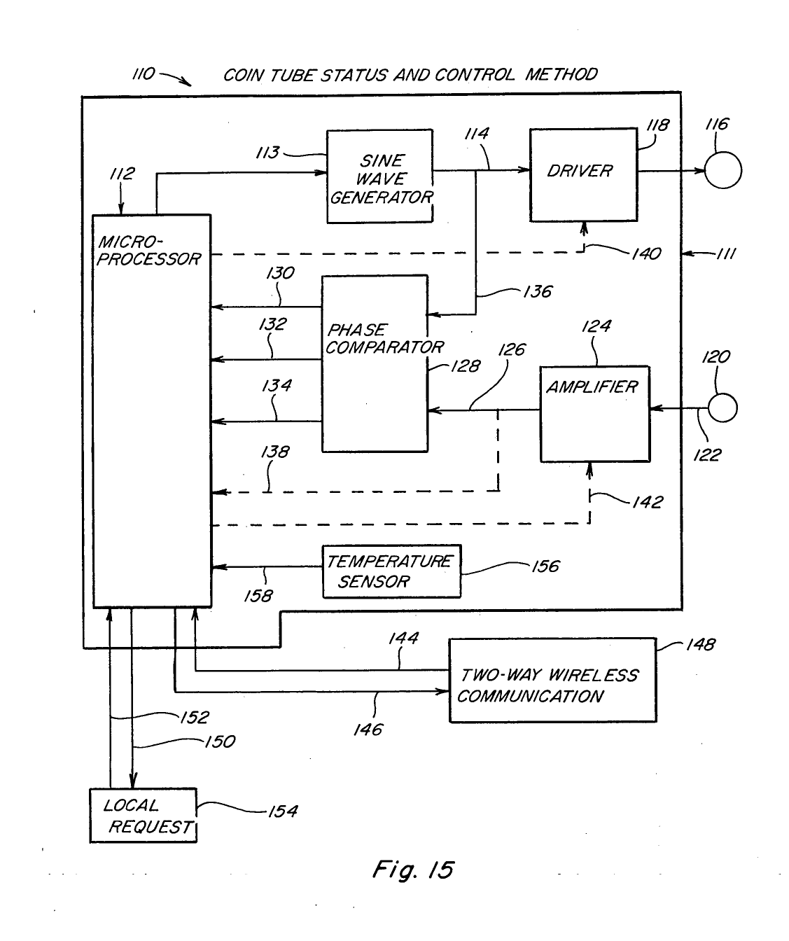

In such regard, it will be appreciated that various circuits and techniques for monitoring signals and for detecting and/or determining the phase relationships between signals are known and could be employed with forms of the embodiment that make use of in-phase detection. Typical of such a circuit is the circuit portion depicted in FIG. 14, which can be employed in a system such as is depicted in FIG. 15.

FIG. 15 depicts in block diagram format a representative construction 110 such as might be utilized to effect the present invention. The construction 110 principally includes a processor and control portion 111 connected to control the application of signals by a speaker 116 and to process information detected by a microphone 120. Basically, processor portion 111 includes the processing and control elements for producing and controlling the signal provided to speaker 116 and for monitoring and responding to the signal provided by microphone 120. Typically, such elements may include a microprocessor 112 connected to control a sine wave generator 113 which operates to produce an output on lead 114 to a driver 118 for applying a sine wave (or other periodic waveform) to the speaker 116. Microphone 120 monitors the resultant signal at the top of the coin tube to produce a detection signal that is communicated over lead 122 to a circuit 124 to be amplified and/or conditioned thereby, as may be required.

A phase comparator 128 is connected to receive incident signal information from the sine-wave generator 113 via lead 136 as well as the detection signal information (corresponding to the detected resultant signal information) from amplifier 124 via lead 126. Phase comparison information is communicated to the microprocessor 112 such as via leads 130, 132, and 134. Phase comparator 128 converts the two input signals on leads 136 and 126 to logic levels for phase comparison purposes and produces an output on lead 130 indicative of the detected phase relationship as well as outputs on leads 132 or 134 when the driving signal frequency is respectively less than or greater than a resonant frequency for the air column above the coin stack. The signal produced on lead 130 provides the indication of the degree of in-phase relationship between the driving and the resultant signals. The signals on leads 132 and 134 can be employed in conjunction with the signal produced on lead 130 to identify an in-phase relationship and/or for determining subsequent applications of driving signals to effect a resonant condition.

The output signal of amplifier 124 may also be provided via lead 138 to the microprocessor 112 for controlling the gain signals provided over lead 140 to the driver 118 and over lead 142 to amplifier 124.

Leads 144 and 146 indicate possible communication pathways between microprocessor 112 and a two-way wireless remote communication portion 148, for RF, infrared, optical, or other forms of wireless data interchange. The communications portion may be of any suitable form, numerous forms of which are known from the prior art.

Interface leads 150 and 152 indicate possible pathways between the microprocessor 112 and a wired or local request portion 154 for receiving and responding to direct wired or local requests. The local request portion 154 may include, by way of example and not of limitation, any of a data entry portion, a display portion, a print portion, or an audio announcement portion, numerous forms and variations of which are known from the prior art, suitable for communication with a system user.

Temperature monitoring may be effected by a temperature sensor 156 connected via lead 158 to the microprocessor 112.

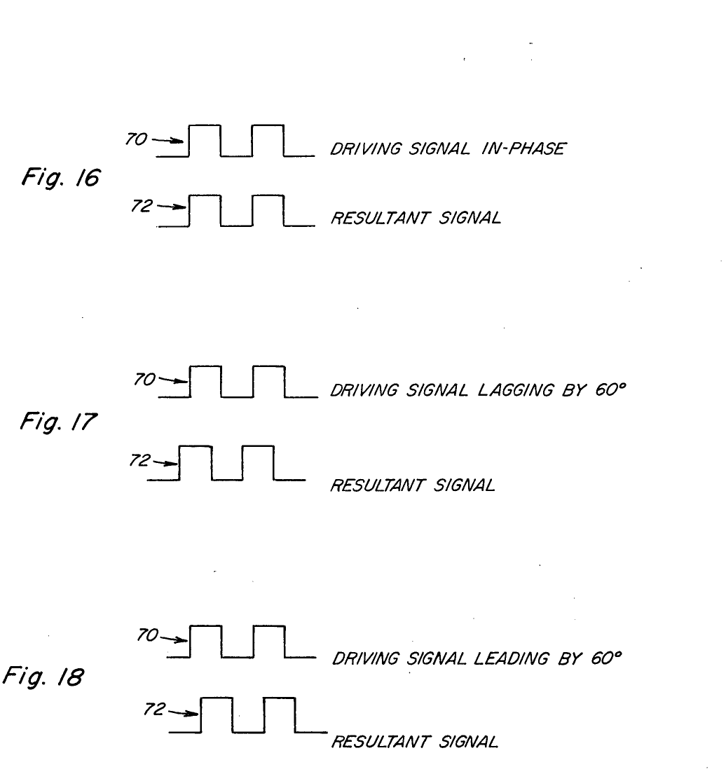

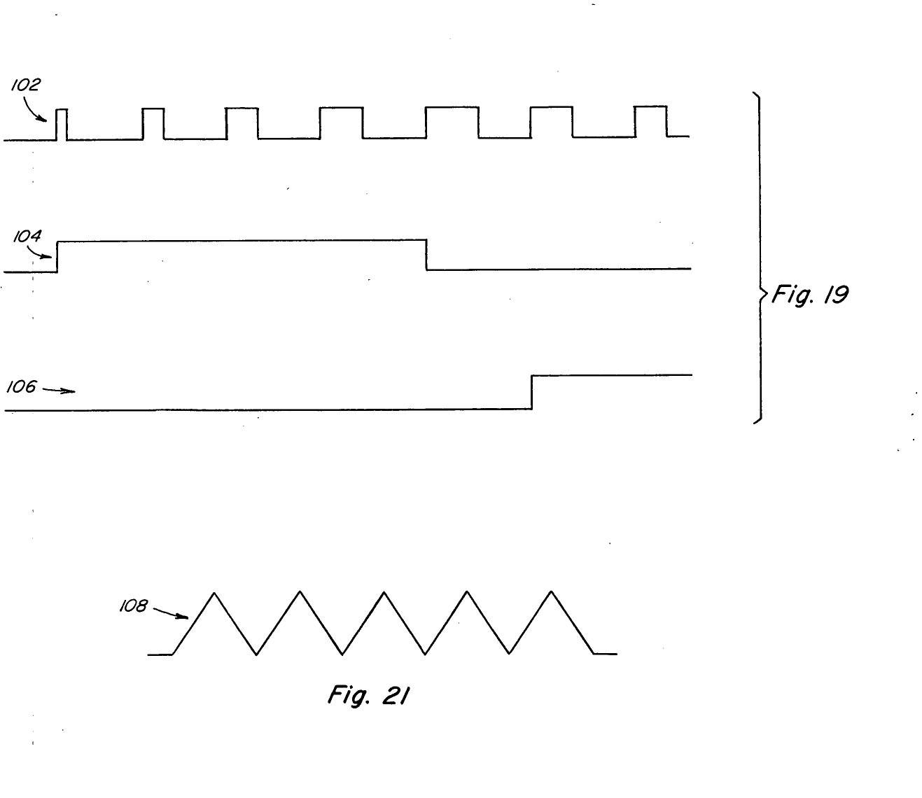

As has been indicated hereinbefore, the phase comparator 128 typically operates to convert the input signals on leads 136 and 126 to logic levels and then utilizes the logic signals to effect output signals on leads 130, 132, and/or 134. A number of phase comparator circuits and techniques utilize digital logic circuits and techniques for such purposes, such as may be better understood by reference to FIGS. 16-18, which figures depict representative logic signals 70 and 72 that may be derived from or which correspond to representative driving and resultant signals for a given air column. In such regard, FIG. 16 depicts logic signals corresponding to a driving signal and a resultant signal where such signals are in-phase; FIG. 17 depicts similar signals where the phase of the driving signal lags the resultant signal by 60°; FIG. 18 depicts like signals where the phase of the driving signal leads the resultant signal by 60°.

FIG. 14 depicts at least a portion of a typical, representative phase comparator 128 such as might be employed with the embodiment of FIG. 15. When logic signals such as the signals 70 and 72 of FIGS. 16-18 are provided to the phase detection circuitry of FIG. 14, such as on lead 136 from sine wave generator 113 and on lead 126 from amplifier 124, such phase detection circuitry is responsive thereto to produce output information indicative of the phase relationship between the driving and resultant signals and for controlling adjustment of the driving signal to effect an in-phase relationship. In the FIG. 14 construction, the driving logic signal 70 is applied over input lead 74 to input 75 and the resultant logic signal 72 is applied over input lead 76 to input 77 of AND gate 78. Such AND gate 78 will produce a HI on its output 79 when both inputs are and a LO for other input conditions. When the driving signal and resultant signal are in-phase, the duty cycle of the output signal on lead 80 will be approximately ½ (i.e., 180° of 360° cycle). If the signals are out-of-phase with one another, the duty cycle will be less than ½ (e.g., a duty cycle of ¼ when the signals are 90° out-of-phase, i.e., 90° of a 360° cycle).

The driving logic signal 70 is also applied over lead 74 to inputs 86 and 100 of D-type flip-flops 84 and 92 and the resultant logic signal is also applied over lead 76 to inputs 88 and 98 of D-type flip-flops 84 and 92. Output 89 of D type flip-flop 84 goes HI when clock input 86 goes HI while “D” input 88 is also HI and output 99 of D type flip-flop 94 similarly goes HI when its clock input 96 goes HI while “D” input 98 is also HI.

Outputs 80, 89, and 90 of FIG. 114 may typically be connected to leads 130, 132, and 134, respectively, of FIG. 15 to communicate information to microprocessor 112.

FIG. 19 depicts representative output signals such as might be produced by the phase detection circuit portion of FIG. 14 and communicated to microprocessor 112 of FIG. 15 as the frequency of a driving signal is adjusted overtime. Waveform 102 depicts a representative phase relationship indicator signal such as might be produced at output 79 in FIG. 14, illustrating the change in waveform that occurs as the frequency of the driving signal increases towards and passes through the resonant frequency of the air chamber for a coin tube being tested. Waveform 104 depicts the corresponding waveform that would be produced at output 89 in FIG. 14 and waveform 106 depicts the corresponding waveform that would be produced at output 99 in FIG. 14.

It will be appreciated by those skilled in the art that a phase detection circuit portion such as that depicted in FIG. 14 can be utilized to provide information to the processing and control circuitry that would permit such circuitry to adjust the frequency of the driving signal until a resonant condition is effected and to further vary the frequency to determine the harmonic status of a resonant frequency. Depending upon the particular method and technique utilized for effecting an in-phase relationship between the driving signal and the resultant signal, the use of some of the outputs of the FIG. 14 circuit may not be utilized or required, as will be appreciated from that which follows. In appropriate circumstances, however, the output signal produced at output 79 of AND gate 78, which is indicative of the difference or variation from a resonant condition, can be analyzed to determine the amount of adjustment required to effect resonance, and the output signals at output 89 of D type flip-flop 84 and output 99 of D type flip-flop 94 can be utilized to indicate whether adjustment required should be achieved by increasing or decreasing the frequency.

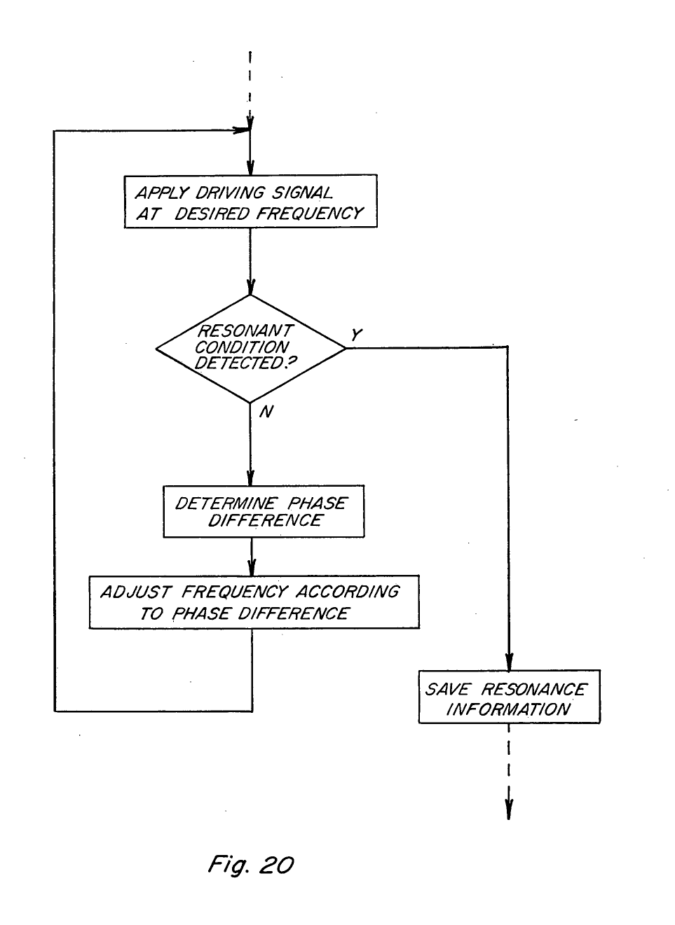

FIG. 20 depicts a high level flowchart illustrative of the manner in which the constructions of FIGS. 14 and 15 can operate to determine and apply, in real-time, succeeding frequencies to effect a resonant condition. It will be appreciated that the looping portion of such flowchart could be substituted for looping portions of FIGS. 11-13 where the next succeeding frequency for the driving signal is being determined and applied.

It will be appreciated that the particular circuit depicted in FIG. 14 is but one example of various phase detection circuit portions that could be advantageously employed with the present invention. Many other circuits and circuit configurations could also be employed.

Although the invention has heretofore been described relative to a zero degree phase differential between the driving and resultant signals as being indicative of air column resonance such a precise standard need not be required or utilized. A different or relaxed reference or standard could also be used, such as being within ±5 degrees or some other standard. Moreover, since the amplitude of the resultant signal increases at resonance, amplitude levels could also or alternatively be referenced to make determinations.

It should also be recognized that while the invention has hereinabove been discussed with reference to driving signals that are sine waves, periodic waveforms other than sine wave can be used if the harmonic content does not interfere with the phase comparisons. FIG. 21 shows a triangle wave 108 as one example of another periodic waveform that can be used for the driving signal.

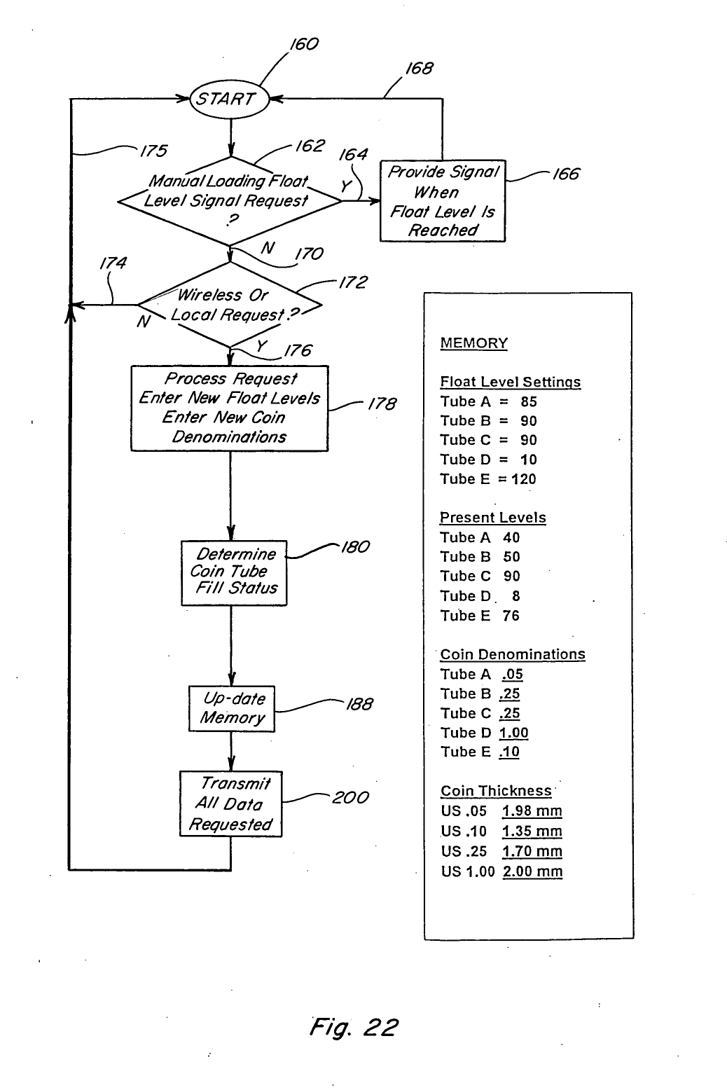

A typical operation of construction 110 of FIG. 15 in a vending environment, where the microprocessor is appropriately programmed to operate in the manner indicated, is generally illustrated by the high level flowchart of FIG. 22. From an entry condition at block 160, operation proceeds to block 162 at which the processing and control portion checks to see if a Manual Loading Float Level Signal Request has been made. If so, operation proceeds along the YES branch 164 to block 166 which operates to then Provide Signal When Float Level Is Reached, at which time operation proceeds along path 166 back to the entry block At block 162, if no Manual Loading Float Level Signal Request is detected, operation then proceeds along NO branch 170 to block 172, at which a check is made as to whether a Wireless or Local Request for coin tube information has been made. If not, operation returns to the entry block 160 along paths 174 and 175.

At block 172, if a Wireless or Local Request for coin tube information is detected, operation proceeds along the YES branch 176 to block 178. The processing and control portion then operates at block 178 to process the request and to enter new float levels and new coin denominations, as may be appropriate and/or required for the request before proceeding to block 180. At block 180, the processing and control portion operates to determine from detected resonant conditions, as differentiable, periodic driving signals are applied over time, the coin count in the coin tube, by any of the forms or embodiments discussed.

When a determination of the coin count has been effected at block 180, operation proceeds to block 188, at which stage all appropriate memory up-dates can be made, and then to block 200, at which stage all requested data is transmitted, before operation proceeds back to the entry block 160.

The transmitted data can thereafter be analyzed at appropriate times and can be utilized for various purposed, including, for example, determining minimum desirable float levels for coins of various denominations.

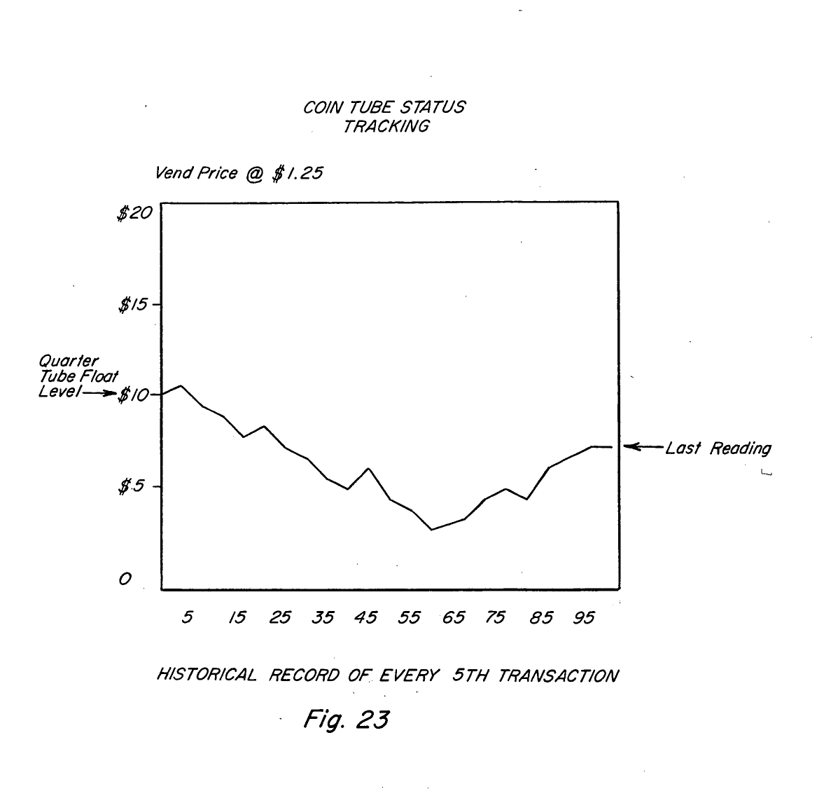

In such regard, and by way of example, FIG. 23 is a graphical representation of a quarter (25¢) tube fill status level such as might be detected over time utilizing the present invention, wherein the line graph depicts the value status of a coin tube count that is recorded every fifth transaction to provide a history for the purpose of evaluating float level settings. For a vend price of $1.25, a customer might typically insert two dollar bills and be credited with $2.00, which would then require a refund of $0.75, which could be supplied in the form of a payout of three quarters from the coin tube. If exact change were required for such a vend, one quarter might be added to the coins in the coin tube. In the real world, not every customer will insert two dollar bills in a non-exact change condition or a dollar bill and one quarter in an exact change condition. Sometimes a customer may deposit five quarters or some other combination of bills and coins to total $1.25. In general, it is desirable for vendors to be able to maintain sufficient coins of a given denomination without maintaining an overabundance of that denomination. The present invention can help with such determination.

If the float level for the quarter tube had been set at $10 and one were desirous of resetting the float level to a lesser amount, the graph of FIG. 23 could be utilized to help determine what lesser amount might be acceptable. If one were to observe the Last Reading as denoted on the graph, such Last Reading might suggest the possibility that a resetting of the Float Level to a value of $5 would be sufficient. However, since the float level had been set at $10, and since the graph indicates that approximately the 45^{th} through the 85^{th} transactions in the monitored period resulted in coin tube float levels at amounts less than $5, resetting the float level to $5 could be expected to result in certain difficulties or in less than desirable vend conditions. Based upon the graph, a new float level of about $8 would appear more reasonable and desirable.

Historical reporting can be made at different transaction periods and duration. The historical data for transmission is shown graphically here for simplicity of illustration.

In accordance with another embodiment of the invention, differentiable, periodic signals of varying frequencies may be applied, such as in an increasing or decreasing fashion over time, to a coin tube of a predetermined height having a coin stack of unknown height therein, and the resultant signals within the air column of the coin tube can be monitored to note the varying amplitudes of the resultant signal as the incident signal is varied. As the incident signal is varied over time, the varying amplitudes of the resultant signals will generally define a varying signal wherein the detected amplitude is associated with the particular frequency of the driving signal. When the amplitudes are plotted relative to the frequencies, the resultant waveform may be viewed as a form of sine wave, or perhaps more accurately, as a waveform that is a combination of a multiple of sine waves.

It will be appreciated and understood by those skilled in the art that a variety of transform theories and theorems have been developed over the years, including Fourier Transforms and Fast Fourier Transforms (FFTs), that address relationships between time and frequency domains and which can be advantageously used in various circumstances to simplify certain problem resolutions. Fourier and Fast Fourier Transform Analysis makes use of the concept that time domain signals can be defined in terms of a plurality or multitude of sine wave signals of differing frequencies. In somewhat similar fashions, other theorems may utilize signals of other types, such as triangular waves of differing frequencies. For ease of discussion, the following discussion will be directed to the use of FFT theorems and analysis, although it should be recognized that other theorems and analyses can likewise be employed.

As has already been noted, in accordance with this embodiment of the invention, differentiable, periodic signals of varying frequencies may be applied, such as in an increasing or decreasing fashion over time, to a coin tube of a predetermined height having a coin stack of unknown height therein, and the resultant signals within the air column of the coin tube monitored to note the varying amplitudes of the resultant signal as the incident signal is varied.

As the incident signal is varied over time, the varying amplitudes of the resultant signals will result in an output signal that may be expressed as a form of sinusoidal signal that is directly related to the length or height of the air column of the coin tube and which may be considered a signature waveform for the air column. By then utilizing Fourier transform analysis, and particularly by taking the Fast Fourier Transform (FFT) of such signature waveform and analyzing the transform result, the fundamental frequency of the air column can be derived, and from such fundamental frequency the height of the coin stack and the number of coins in the stack can thereafter be determined in the manner as previously discussed hereinabove.

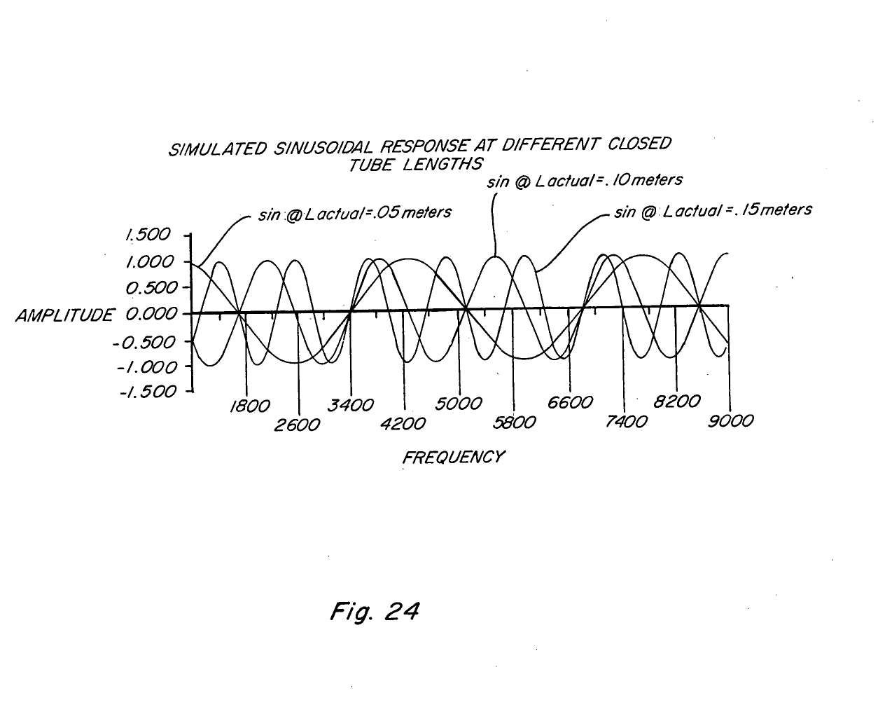

It will be appreciated by those skilled in the art that, when a periodic signal is directed into the coin tube, the detected amplitude of the resultant signal will be attenuated and will be dependent upon the relationship of the periodicity of the incident signal and the height of the air column. In general, when the periodic incident signal is a sinusoidal signal, the amplitude of the resultant signal will satisfy the equation
A˜sin(2πf_{I}(2 [symbol] _{A}/v)),
where f_{I}, is the frequency of the incident wave, [symbol] _{A} is the length (height) of the air column, v is the velocity of sound in dry air, and A is the resultant amplitude. By sampling the resultant signal over a period of time at or near the top of the tube as a sequence of incident signals of different frequencies is applied, and recording the amplitudes of the resultant signals associated with the incident signal frequencies, a signature waveform for the height of air column can thus be generated. This signal (see FIG. 24) will be a sinusoidal-type frequency domain signal that is directly related to the length of the tube.

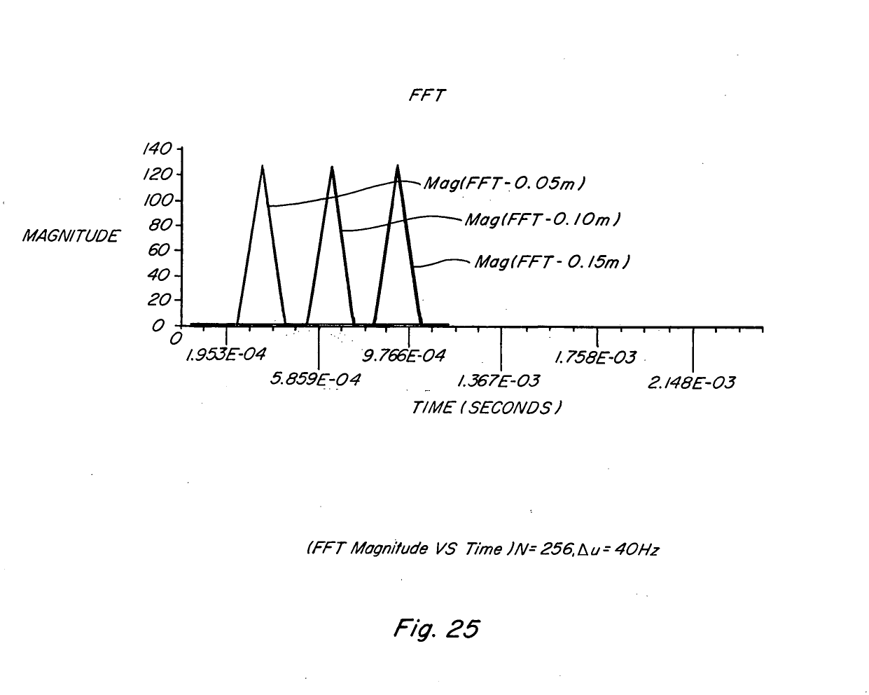

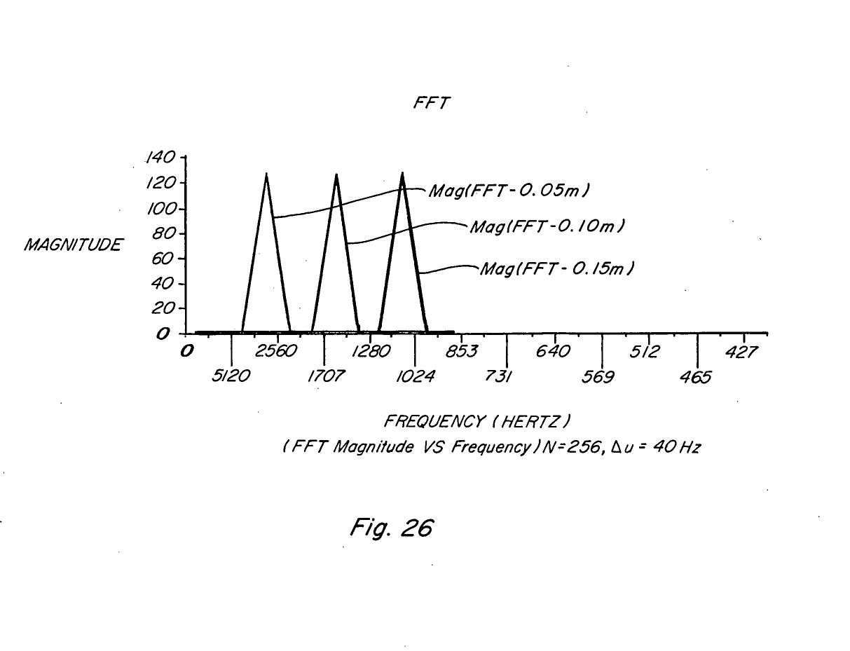

Extracting the relationship between the response signal and the length of the tube is not an obvious exercise. The process begins by application of a FFT on the signature waveform. See FIGS. 25 and 26. Since the signature waveform is a frequency domain signal, the FFT transforms it to a time domain signal.

In accordance with FFT theory, the peak magnitude Aₚ of the FFT signal is inversely proportional to a frequency value fₚ which, in the closed-end environment of a coin tube, is twice the fundamental frequency. Thus,
f_{FA}=fₚ/2,
where fₚ is the frequency associated with the peak amplitude.

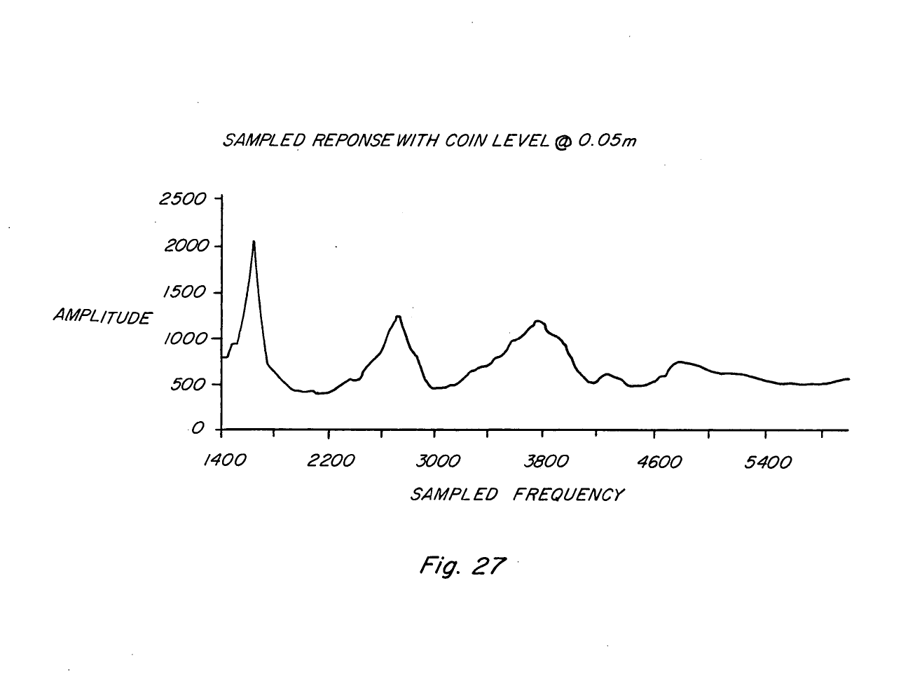

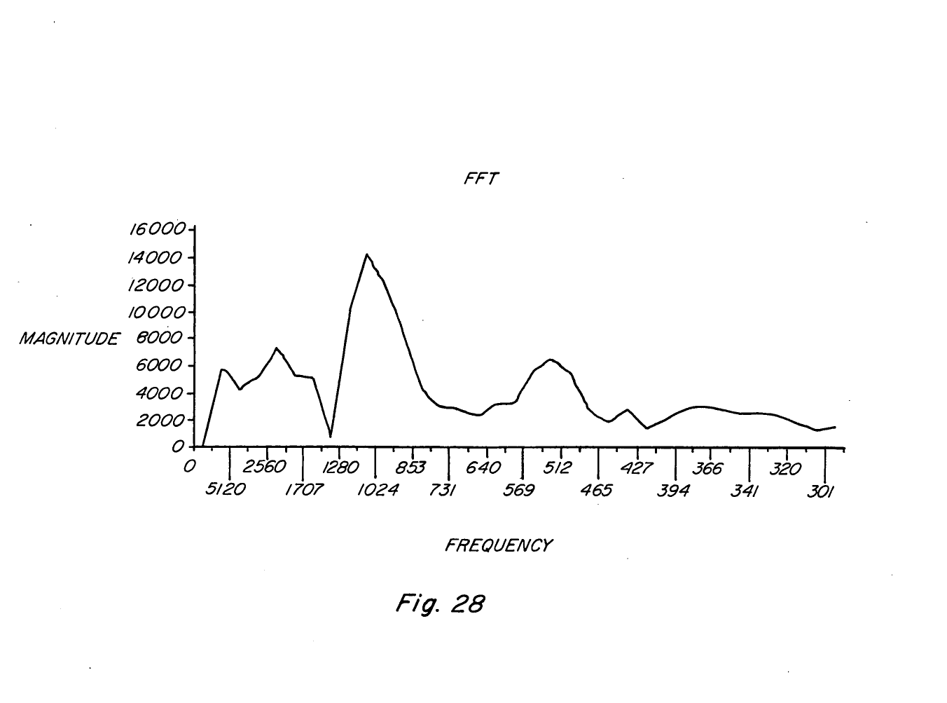

It has been observed that if a 0.20 m. tube is provided and coins are stacked therein to a coin stack height of 0.05 m. leaving an air column of 0.15 m., and incident waveforms are periodically introduced into the top of the tube in 40 Hz increments from 1400 Hz to 6000 Hz (the limitations of the speaker employed), a plot of the amplitudes of the resultant signals corresponding to the incident signals results in a signature waveform, such as set forth in FIG. 27. It has been found preferable, before taking the FFT of the signature waveform, to adjust the magnitude values to a zero average, thereby normalizing the magnitudes to minimize any DC influence. When a FFT is then applied to such signature waveform, an FFT transform waveform, such as set forth in FIG. 28 is produced. As can be observed, the peak magnitude of such transform waveform occurs at a frequency of about 1138 Hz. Since such frequency represents twice the fundamental frequency, the fundamental frequency is thus determined to be 569 Hz. for this example.

In accordance with the principles and equations addressed hereinbefore, for a 0.20 m. tube with a determined fundamental frequency of 569 Hz, one would expect the height of the air column to be [symbol]
_{A}=0.1507 m.
and the coin stack height to be [symbol]
_{C}=0.2 m−0.1507 m=0.0493 m.,
thus verifying, for this particular example, the efficacy of the embodiment utilizing the FFT. Additional verifications have been and can similarly be realized with other lengths of coin tubes and with various coin stack heights to confirm that FFT principles can be relied upon and utilized to determine coin tube status.

In accordance with FFT principles, however, it should be recognized that, in order to obtain accurate and reliable transform results, the sampling rate must be at least twice the maximum frequency applied.

With respect to the various embodiments and forms thereof that have been discussed herein, it should be noted that the periodic nature of the signal is the key, not the particular range of frequencies used to extract the sample data. Therefore, although these discussions have primarily been presented with reference to frequencies in the audio frequency range, it should be appreciated that it would be possible, with appropriate transducers, to utilize frequencies that are above the audio range. (e.g. 20 Khz, 40 Khz, 75 Khz, etc.). In such regard, in general, it is preferred that higher frequencies be employed, when possible, due to their shorter wavelengths and the shorter time durations of application that may be required

Additionally, while the foregoing discussions have, for convenience and ease of description, been directed primarily to single coin tubes, it will be understood that multiple coin tubes may be monitored utilizing common components and methods, which can enhance the efficiency and minimize costs of coin handling devices.

All of the methods and their implementations as addressed herein can be advantageously employed with products and services intended for unattended points of sale where coins, tokens, or items of value are stored and may be inventoried and controlled in real-time from remote locations, including wireless transmission.

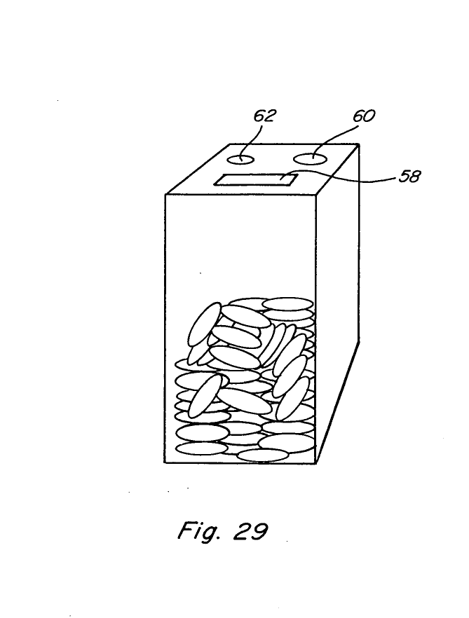

While the discussion to this point has been primarily addressed to coin tubes and to coin stacks therein and air columns above the stacked coins, it should be understood that the invention is not limited to use with coin tubes, but can also be employed with various types of caches. For example, FIG. 29 is a simplified representation of a bulk loaded coin hopper 53 having a coin entrance 55, a small speaker 56, and the microphone 58. The coins 59 are depicted in a bulk loaded random “stack”. With such an environment, an approximate count of the number of coins in the coin cache can be obtained by means of the formula
n=V_{S}/V_{C},
where V_{S} is the volume of the coin “stack” and V_{C} is the volume of a coin of the coin denomination in the coin cache. Since the coins are not necessarily susceptible to a neatly ordered stacking, the coin count may not be as accurate as the count for coins stacked in a coin tube sized to accommodate coins of a given denomination, but may be useful as a reasonable approximation.

It will be appreciated that this invention can also be utilized in a vending environment to periodically check the status of one or more coin tubes, and, in so doing, to be able to also determine when a coin or coins enter or leave such coin tubes, as well as to check whether the con tube has become empty or full or has reached a particular intermediate state.

By use of a temperature sensor, the invention can provide temperature compensation and generally realize more accurate results. In many, instances, sufficient accuracy of results may be achieved by utilizing, as a constant, a particular value for the speed of sound in dry air, regardless of temperature changes, especially if the temperature variation is relatively small. However, more accurate results may be realizable when determinations are made based upon actual temperature.

Although it is preferable, for ease of construction and calculations, that the speaker and microphone of the present invention be positioned at approximately the same heights at or near the top of a coin tube, it should be appreciated that that they may be placed at differing heights in certain embodiments, provided appropriate compensation is made for the difference in heights, and that the speaker and microphone may also be placed at heights spaced above the coin tube, which experience has shown can be up to at least an inch or more above the coin tube in some instances, depending upon the characteristics and quality of the speaker and microphone employed, without deleteriously impacting the operation of the invention embodiment. If the difference in heights of the speaker and microphone is minimal or within some range, and acceptably accurate results are obtained without any compensation for the difference in heights, it may not be necessary to provide for any compensation, but if the differences in height become significant, especially to the extent that the difference may affect the accuracy required of the embodiment, it may then be desirable to check to see if the resultant signal, instead of being in-phase with the incident signal, is in some other desired relationship, such as, for example, a 10° out-of-phase condition. It should be appreciated that placements of the speaker and microphone at different heights may have more impact upon certain embodiments, such as embodiments that check for in-phase conditions, than other embodiments, such as an embodiment that utilizes the detection of a signature waveform and the application of an FFT to such waveform.

Thus, there has been shown and described novel tube sensing method and control and various embodiments and forms thereof. It will be apparent to those skilled in the art, however, that many changes, modifications, variations, and other uses and applications of the method and control are possible. All such changes, modifications, variations, and other uses and applications which do not depart from the spirit and scope of the invention are deemed to be covered by the invention which is limited only be the claims which follow.

What is claimed is:

1. A method for determining the number of coins in a coin cache associated with a coin handling apparatus, wherein the coin cache is configured to receive and hold coins therein generally adjacent to a first end thereof in a generally layered arrangement, said first end and any such layered coins defining a closed end of the coin cache, and wherein the air space between such closed end of the coin cache and the opposed end of the coin cache comprises an air chamber, the coin handling apparatus including a speaker positioned at a known distance from the first end of the coin cache and oriented to direct periodic incident signals into the air chamber of the coin cache toward the closed end thereof, a microphone positioned at a known distance from the first end of the coin cache and oriented to receive resultant signals effected within the air chamber of the coin cache in response to application of the incident signals, and a control portion operatively connected to the speaker and the microphone for controlling the application of incident signals from the speaker into the coin cache and for reacting to resultant signals received by the microphone, the method comprising:
a) providing a coin cache having a given length for holding coins therein,
b) directing, under control of the control portion of the coin handling apparatus, in sequence, a plurality of periodic incident signals from the speaker into said coin cache, said incident signals having periodic waveforms of different wavelengths, each incident signal having known characteristics maintained by the control portion and effecting a corresponding resultant signal within the air chamber as the incident signal is directed into the air chamber and impinges the closed end of the air chamber and reflects therefrom, with the continuing incident signal and its reflection interacting with one another, the control portion
c) monitoring, under control of the control portion of the coin handling apparatus, the resultant signals received by the microphone and the characteristics of the resultant output signals, a given periodic incident signal resulting in a corresponding resultant signal dependent upon the length of the air chamber,
d) determining, from the known characteristics of the periodic incident signals and from observed characteristics of corresponding resultant signals, the number of coins or tokens in the coin cache.

2. The method of claim 1 wherein step d includes determining the length of the air chamber, determining the length of the space occupied by coins, and determining from said occupied space determination the number of coins in the occupied space.

3. The method of claim 2 wherein the number of coins in the coin cache is a function of the thickness of a coin and the length of space occupied by such coins.

4. The method of claim 3 wherein the coin cache has a tube-like configuration and is sized to accommodate a single stack of coins of a given size and denomination.

5. The method of claim 4 wherein the speaker and microphone are positioned at the same approximate height relative to the first end of the coin cache.

6. The method of claim 1 wherein the determination of the length of the air chamber is dependent, in part, upon a temperature value employed and maintained by the control portion.

7. The method of claim 6 wherein a constant temperature value is employed.

8. The method of claim 6 wherein said coin handling apparatus includes a temperature sensor and the control portion utilizes the temperature detected by the temperature sensor in making the determination of the length of the air chamber.

9. The method of claim 1 wherein step b includes maintaining as known characteristics the frequencies of the incident signals that are applied.

10. The method of claim 1 wherein step b includes providing the incident signals for time periods sufficient for the incident signal being provided to effect a responsive resultant signal receivable by the microphone.

11. The method of claim 10 wherein step b further includes providing a plurality of incident signals of differing frequencies in an incremental fashion.

12. The method of claim 11 wherein said incident signals are provided until at least two resonant conditions are effected within the air chamber.

13. The method of claim 12 wherein the occurrence of a resonant condition is considered to be established when the difference in phase between an incident signal and its corresponding resultant signal is within a given range.

14. The method of claim 12 wherein the occurrence of a resonant condition is considered to be established when an incident signal and its corresponding resultant signals are detected to be essentially in-phase with one another.

15. The method of claim 12 wherein resonant conditions are considered to be established when the magnitudes of the resultant signals are maximal.

16. The method of claim 11 wherein the frequencies of the plurality of incident signals applied are pre-established.

17. The method of claim 11 wherein a first set of incident signals is applied until a first resonant condition is detected, and a second set of incident signals is thereafter applied, the second set being dependent upon the frequency at which the first resonant condition was detected.

18. The method of claim 17 wherein the frequencies of the second set of incident signals are harmonically related to the frequency at which the first resonant condition was detected.

19. The method of claim 1 wherein step b includes maintaining as known characteristics the frequencies of the incident signals that are applied, step c includes saving values corresponding to the magnitude values of respective detected resultant signals as associated with the frequencies of the incident signals effecting such resultant signals, such saved information defining a signature waveform for the air chamber of the coin cache, and step d includes the steps of applying a mathematical transform to said signature waveform to obtain a transform waveform whose peak amplitude is associated with a frequency value indicative of the fundamental frequency for the air chamber.

20. The method of claim 19 wherein said mathematical transform is a Fast Fourier Transform-like transform.

21. The method of claim 20 wherein the frequency value indicative of the fundamental frequency is twice the fundamental frequency.

22. The method of claim 20 wherein step d further includes determining the length of the air chamber from the fundamental frequency and the given length of the coin cache, thereafter determining the length of the space occupied by coins or tokens, and then determining from said occupied space determination the number of coins in the occupied space.

23. The method of claim 20 wherein said mathematical transform is related to the form of the incident signals applied.

24. The method of claim 23 wherein the incident signals are essentially sinusoidal in form and the mathematical transform makes use of a form of Fourier transform analysis.

25. The method of claim 23 wherein the incident signals are essentially triangular in form and the mathematical transform makes use of a form of triangular wave transform analysis.

26. The method of claim 19 wherein the sampling rate is at a rate least twice the maximum frequency applied.

27. The method of claim 1 wherein the frequencies of the incident signals are in the audio range.

28. The method of claim 1 wherein at least some of the frequencies of the incident signals are above the audio range.

29. The method of claim 1 wherein step c includes the step of determining from an incident signal and the corresponding resultant signal a phase relationship therebetween and utilizing said determined phase relationship to establish the frequency for a subsequent incident signal.

30. The method of claim 1 wherein the method is initiated under control of the control portion of the coin handling apparatus.

31. The method of claim 30 wherein the method is initiated under control of the control portion of the coin handling apparatus automatically upon a periodic basis.

32. The method of claim 30 wherein the method is initiated under control of the control portion of the coin handling apparatus upon recognition by the control portion of a request for coin cache status information.

33. The method of claim 32 further including the step of saving the requested coin cache status information.

34. The method of claim 33 wherein the request for coin cache information is communicated to the control portion from a requesting source and the saved coin cache status information is transmitted to the requesting source.

35. The method of claim 34 wherein the requesting source is an internal source associated with the coin handling apparatus.

36. The method of claim 34 wherein the requesting source is a source external to the coin handling apparatus.

37. The method of claim 32 wherein saved coin cache information for multiple initiations of the method defines a historical record of coin cache status over a period of time and said record is employable to establish float levels for the coin cache.

38. A coin cache status determination system comprising
a coin cache having a given length and first and second ends, said coin cache configured to receive and hold coins therein generally adjacent to said first end thereof in a generally layered arrangement, said first end and any layered coins adjacent thereto establishing a substantially closed end to said coin cache, said coin cache including an air space between said closed end and the second end of the coin cache, said air space between said closed end and said second end defining an air chamber,
a speaker positioned at a known distance from the first end of the coin cache and oriented to direct incident signals into the air chamber of the coin cache toward the closed end thereof to impinge upon the closed end and to reflect therefrom, the resulting combination of effects of an incident signal and its reflection establishing a resultant signal within said air chamber, introduction of a given periodic incident signal into the air chamber effecting a corresponding resultant signal within said air chamber dependent upon the length of said air chamber,
a microphone positioned at a known distance from the first end of the coin cache and oriented to receive resultant signals effected within the air chamber and to produce corresponding output signals representative of said resultant signals and their characteristics, and
a control portion operatively connected to the speaker and the microphone for controlling and effecting the sequential application of differing periodic incident signals from the speaker into the coin cache and for reacting to the output signals from the microphone representative of respective, corresponding resultant signals and their characteristics, the characteristics associated with said incident signals being controllable by said control portion, said characteristics associated with said incident signals determining the wavelengths and frequencies of said incident signals,
said control portion operable to determine, from characteristics associated with the periodic incident signals and from characteristics associated with corresponding resultant signals, the number of coins in the coin cache.

39. The system of claim 38 wherein said control portion is operable to determine, from said characteristics associated with said incident signals and the characteristics associated with their respective, corresponding resultant signals, the length of the air chamber, the length of the space occupied by coins, and the number of coins in the occupied space.

40. The system of claim 39 wherein the number of coins in the coin cache is a function of the thickness of a coin and the length of space occupied by such coins.

41. The system of claim 40 wherein the coin cache has a tube-like configuration and is sized to accommodate a single stack of coins of a given size and denomination.

42. The system of claim 39 wherein said control portion includes a temperature sensor portion, said processor portion operatively connected to said temperature sensor to utilize the temperature detected by the temperature sensor in making the determination of the length of the air chamber.

43. The system of claim 38 further including a communications portion operatively connected to said control portion and operable to receive from and to transmit to external sources information of interest.

44. The system of claim 38 further including a local request portion operatively connected to said control portion and operable to provide for the communication of information from said local request portion to said control portion and from said control portion to said local request portion.

45. The system of claim 44 wherein said local request portion includes a data entry portion for entry of information into the system by a user and a display portion for displaying to a user information from the control portion.

46. The system of claim 38 wherein said control portion includes a wave generator portion operatively connected to said speaker to provide a signal wave to the speaker and a processor portion operatively connected to said wave generator portion to provide information thereto to effect the production of incident signals from said speaker, said processor portion operable to determine, from characteristics associated with the periodic incident signals and from characteristics associated with corresponding resultant signals, the fundamental frequency for the air chamber.

47. The system of claim 46 wherein said control portion is operable to detect a resonant condition for said air chamber.

48. The system of claim 47 wherein said control portion includes a phase detector portion operatively connected to said driver portion to receive information therefrom representative of the incident signals and to said speaker to receive information therefrom representative of the respective resultant signals effected by introduction of said incident signals into said air chamber, said phase detector portion operable to detect the occurrence of a particular phase relationship between an incident signal and its respective, corresponding resultant signal and to communicate to said processor portion information indicating the detection of such a resonant condition, said processor portion operable to associate the detection of a resonant condition with the frequency of the incident signal that resulted in the occurrence of the resonant condition and to identify such frequency as a resonant frequency for said air chamber.

49. The system of claim 48 wherein said control portion includes an amplifier portion operatively connected between said microphone and said phase detector portion to condition the output signals from the speaker for use by the phase detector portion.

50. The system of claim 49 wherein said control portion and speaker, said wave generator portion operable to produce a given wave under control of said processor portion and said driver portion operable to respond to said given wave from said wave generator portion to drive the speaker.

51. The system of claim 50 wherein said processor portion is operatively connected to receive signals from said amplifier portion and to transmit signals to said driver portion and said amplifier portion to alter the signal conditioning provided by said driver portion and said amplifier portion.

52. The system of claim 48 wherein said processor portion is operable to determine from a plurality of identified resonant frequencies the fundamental frequency for said air chamber.

53. The system of claim 52 wherein said processor portion is operable to determine, from said fundamental frequency, the length of said air chamber; from the length of the coin cache and the length of the air chamber, the length of space occupied by layered coins or tokens; and, from the length of space occupied by layered coins and the known thickness of a coin of a given denomination, the number of coins of said given denomination in the coin cache.

54. The system of 53 wherein said processor portion includes a programmed microprocessor.

55. The system of claim 48 wherein said control portion includes a temperature sensor portion, said processor portion operatively connected to said temperature sensor to utilize the temperature detected by the temperature sensor in making a determination of the length of the air chamber.

56. The system of claim 38 wherein said control portion is operable to maintain and save as known characteristics the frequencies of the incident signals that are applied and to save values corresponding to the magnitude values of respective detected resultant signals as associated with the frequencies of the incident signals effecting such resultant signals, such saved information defining a signature waveform for the air chamber of the coin cache, said control portion further operable to apply a mathematical transform to said signature waveform to obtain a transform waveform whose peak amplitude is associated with a frequency value indicative of the fundamental frequency for the air chamber.

57. The system of claim 56 wherein said mathematical transform is a Fast Fourier Transform-like transform.

58. The system of claim 57 wherein the frequency value indicative of the fundamental frequency is twice the fundamental frequency.

59. The system of claim 57 wherein said control portion is further operable to determine the length of the air chamber from the fundamental frequency and the given length of the coin cache, to thereafter determine the length of the space occupied by coins or tokens, and to then determine from said occupied space determination the number of coins in the occupied space.

60. The system of claim 57 wherein said mathematical transform is related to the form of the incident signals applied.

61. The system of claim 60 wherein the incident signals are essentially sinusoidal in form and the mathematical transform makes use of a form of Fourier transform analysis.

62. The system of claim 60 wherein the incident signals are essentially triangular in form and the mathematical transform makes use of a form of triangular wave transform analysis.

63. The system of claim 56 wherein the sampling rate is at a rate least twice the maximum frequency applied.

64. The system of claim 56 wherein said control portion includes a programmed microprocessor.

65. In a coin handling apparatus including a coin cache having a given length and first and second ends, wherein the coin cache is configured to receive and hold coins therein generally adjacent to said first end thereof in a generally layered arrangement, wherein such first end and any layered coins adjacent thereto establish a substantially closed end to the coin cache, wherein the coin cache includes an air space between the closed end and the second end of the coin cache, and wherein the air space between said closed end and said second end defining an air chamber, the improvement comprising
a speaker positioned at a known distance from the first end of the coin cache and oriented to direct incident signals into the air chamber of the coin cache toward the closed end thereof to impinge upon the closed end and to reflect therefrom, the resulting combination of effects of an incident signal and its reflection establishing a resultant signal within the air chamber, introduction of a given periodic incident signal into the air chamber effecting a corresponding resultant signal within the air chamber dependent upon the length of the air chamber,
a microphone positioned at a known distance from the first end of the coin cache and oriented to receive resultant signals effected within the air chamber and to produce corresponding output signals representative of said resultant signals and their characteristics, and
a control portion operatively connected to the speaker and the microphone for controlling and effecting the sequential application of differing periodic incident signals from the speaker into the coin cache and for reacting to the output signals from the microphone representative of respective, corresponding resultant signals and their characteristics, the characteristics associated with said incident signals being controllable by said control portion, said characteristics associated with said incident signals determining the wavelengths and frequencies of said incident signals,
said control portion operable to determine, from characteristics associated with the periodic incident signals and from characteristics associated with corresponding resultant signals, the number of coins in the coin cache.

66. The improvement of claim 65 wherein said control portion is operable to determine, from said characteristics associated with said incident signals and the characteristics associated with their respective, corresponding resultant signals, the length of the air chamber, the length of the space occupied by coins, and the number of coins in the occupied space.

67. The improvement of claim 66 wherein the number of coins in the coin cache is a function of the thickness of a coin and the length of space occupied by such coins.

68. The improvement of claim 67 wherein the coin cache has a tube-like configuration and is sized to accommodate a single stack of coins of a given size and denomination.

69. The improvement of claim 66 wherein said control portion includes a temperature sensor portion, said processor portion operatively connected to said temperature sensor to utilize the temperature detected by the temperature sensor in making the determination of the length of the air chamber.

70. The improvement of claim 65 further including a communications portion operatively connected to said control portion and operable to receive from and to transmit to external sources information of interest.

71. The improvement of claim 65 further including a local request portion operatively connected to said control portion and operable to provide for the communication of information from said local request portion to said control portion and from said control portion to said local request portion.

72. The improvement of claim 71 wherein said local request portion includes a data entry portion for entry of information into the system by a user and a display portion for displaying to a user information from the control portion.
